(19) United States
(12) Patent Application Publication
(10) Pub. No.: US 2014/0150170 A1
(43) Pub. Date: Jun. 5, 2014

(54) VARIABLY-TENSED COMPOSITE CUSHIONING MATERIAL AND METHOD FOR MAKING THE SAME

(71) Applicant: Applied FT Composite Solutions Inc., Las Vegas, NV (US)

(72) Inventor: Daniel Kim, Busan (KR)

(73) Assignee: Applied FT Composite Solutions Inc., Las Vegas, NV (US)

(21) Appl. No.: 13/922,133

(22) Filed: Jun. 19, 2013

Related U.S. Application Data
(63) Continuation of application No. PCT/US11/67429, filed on Dec. 27, 2011.
(60) Provisional application No. 61/427,148, filed on Dec. 24, 2010.

(51) Int. Cl. B32B 3/18; A43B 23/02; B32B 38/00; A41D 13/015

(52) U.S. Cl. CPC B32B 3/18; A41D 13/015; A43B 23/0225; B32B 38/0012; B32B 38/0004
USPC 2/459; 2/455; 36/45; 2/22; 2/16; 428/44; 156/163

(57) ABSTRACT

The present application discloses a composite cushioning material comprising two or more resilient elements bonded to one or more flexible or stretchable substrates, further comprising at least one framing element placed around one or more resilient elements, wherein a section of the composite cushioning material corresponding to the area of the framing element is less flexible than the rest of the composite cushioning material, so as to provide a variably tensed composite cushioning material.

### BACKGROUND OF THE INVENTION

### Field of the Invention

The invention relates to the field of composite cushioning material having variably tensed components.

### SUMMARY OF THE INVENTION

The invention relates to a composite structure for use as cushioning material. The composite cushioning material includes a plurality of resilient, shock-absorbing elements bonded to one or two flexible and stretchable substrate layers. The composite material also includes one or more framing elements that cause substrate layers in different areas or zones of the composite structure to be stretched to a different degree, or “variably tensed.” This composite cushioning material is lightweight and stretchable, and it can be made to take on a concave or convex shape, so as to better follow the contour of the wearer's body, hand, or foot, or to fully envelop the body parts that are intended to be protected, yet be flexible and breathable. Once assembled, the material can be used as cushioning component in footwear, as protective padding, or as components in athletic or industrial protective gear. The invention also relates to a method for making the said composite cushioning material.

In one aspect, the invention is drawn to a composite cushioning material comprising two or more resilient elements bonded to one or more flexible or stretchable substrates, further comprising at least one framing element placed around one or more resilient elements, wherein a section of the composite cushioning material corresponding to the area of the framing element is less flexible than the rest of the composite cushioning material, so as to provide a variably tensed composite cushioning material.

The resilient element may be composed, without limitation, of ethylene vinyl acetate foam, olefin or polyolefin foam, polyurethane foam, urethane based foam, thermoplastic foam, or other polymer foam, rubber, elastomer, or other resilient material, including a combination of any such materials. The resilient element may be in the shape, without limitation, of a cube, flattened cube, cuboid, square cuboid, rectangular cuboid, cylinder, circular cylinder, round cylinder, elliptical cylinder, triangular prism, pentagonal prism, hexagonal prism, tapered pyramid, an irregular shape, or a prism with an irregularly shaped cross-section. The resilient elements may have different shapes or dimensions in a group of resilient elements, or may have the same shapes or dimensions in a group of resilient elements. The resilient elements may be sandwiched between two substrates, which may be made of different or same material.

The framing element may be composed, without limitation, of ethylene vinyl acetate foam, olefin or polyolefin foam, polyurethane foam, urethane based foam, thermoplastic or thermoplastic foam, polymer foam, neoprene, natural leather, synthetic leather, elastomer, rubber, plastic, latex, silicone, or other similar material, including a combination of any such materials. The framing element may be bonded to one substrate, or may be bonded to two substrates. The framing element may be comprised of strips or bars of resilient materials that occupy a space between at least two resilient elements. The framing element may be comprised of more than one framing element stacked on top of each other. The framing element may be composed of resilient material, comprised of:

(a) entirely of strips or bars of resilient material;

(b) a lattice of resilient material with apertures; or

(c) a combination of (a) or (b) in the same structure or on separate structures.

The lattice of resilient material may have an outer perimeter that is, without limitation, square-shaped, circularly-shaped, hexagon-shaped, or asymmetrically-shaped, with aperture that is, without limitation, triangular, cylindrical, square, rectangular, pentagonal, or hexagonal.

In another aspect, the invention is drawn to, without limitation, an athletic gear, an industrial protective gear, a shoe upper, a shoe sidewall, a shoe heel counter, a shoe toebox, an elbow pad, a knee pad, or a shoulder pad comprising the composite cushioning material.

In yet another aspect, the invention is drawn to a method of making the composite cushioning material, comprising:

(i) applying a suitable adhesive to one or two opposing surfaces of a sheet of resilient material;

(ii) cutting the sheet of resilient material, to define and make a plurality of resilient elements;

(iii) bonding the plurality of resilient elements to at least one substrate layer;

(iv) stretching the substrate layer to which the resilient elements are bound, and increasing the relative distance between the resilient elements, thereby creating spacing between them;

(v) positioning one or more framing elements shaped and sized to engage one or more resilient elements, or placed between the resilient elements; and

(vi) inserting one or more framing elements between at least two resilient elements, or engaging one or more resilient elements to one or more apertures in the framing element.

The resilient element may be composed of, without limitation, ethylene vinyl acetate foam, olefin or polyolefin foam, polyurethane foam, urethane based foam, thermoplastic foam, or other polymer foam, rubber, elastomer, or other resilient material, including a combination of any such materials. The resilient element may be in the shape of, without limitation, a cube, flattened cube, cuboid, square cuboid, rectangular cuboid, cylinder, circular cylinder, round cylinder, elliptical cylinder, triangular prism, pentagonal prism, hexagonal prism, tapered pyramid, an irregular shape, or a prism with an irregularly shaped cross-section. The resilient elements may have the same or different shapes or dimensions in a group of resilient elements.

The framing element may be composed of, without limitation, ethylene vinyl acetate foam, olefin or polyolefin foam, polyurethane foam, urethane based foam, thermoplastic or thermoplastic foam, polymer foam, neoprene, natural leather, synthetic leather, elastomer, rubber, plastic, latex, silicone, or other similar material, including a combination of any such materials. The framing element may comprise an enclosed structure, wherein the enclosed structure portion comprises one or more apertures, which are engaged with one or more resilient elements. The framing element may comprise strips or bars of resilient materials that occupy a space between at least two resilient elements.

The stretching may occur in an area or zone of the substrate layer to which the resilient elements are bound, and increasing the relative distance between the resilient elements positioned within the said area or zone of the substrate layer, thereby creating spacing between them.

In step (iv), the stretching may be carried out mechanically.

In step (v) the framing element may comprise:

(a) entirely of strips or bars of resilient material;

(b) a lattice of resilient material with apertures; or

(c) a combination of (a) or (b) in the same structure or on separate structures.

The method may alternatively comprise:

(vii) releasing the stretched out substrate so as to retract the substrate; and

(viii) bonding a second substrate to the resilient elements so that the resilient elements and the framing element are sandwiched between the two sheets of substrates to form a dual laminate composite.

The method may also alternatively comprise:

(vii) releasing the stretched out substrate so as to retract the substrate;

(viii) bonding the framing element to the substrate layer, thereby making a single laminate composite; and

(ix) bonding a second substrate to the resilient elements so that the resilient elements and the framing element are sandwiched between the two sheets of substrates to form a dual laminate composite.

An optional step (vii) may involve bonding a second substrate to the resilient elements so that the resilient elements and the framing element are sandwiched between the two sheets of substrates to form a dual laminate composite in which the framing element is not bound to either substrate. The stretched out substrate may then be released so as to retract the substrate after step (vii).

An alternative optional step (vii) may involve bonding the framing element to a substrate layer, thereby making a single laminate composite with the framing element bound to one substrate. The stretched out substrate may then be released so as to retract the substrate after step (vii).

An optional step (viii) may involve bonding a second substrate to the resilient elements so that the resilient elements and the framing element are sandwiched between the two sheets of substrates to form a dual laminate composite in which the framing element is bound to one substrate. The stretched out substrate may then be released so as to retract the substrate after step (viii).

An alternative optional step (viii) may involve bonding a second substrate to the resilient elements and the framing element so that the resilient elements and the framing element are sandwiched between the two sheets of substrates to form a dual laminate composite in which the framing element is bound to both substrates. The stretched out substrate may then be released so as to retract the substrate after step (viii).

In yet another aspect, the invention is directed to a composite cushioning material comprising two or more resilient elements bonded to one or more flexible or stretchable substrates, further comprising at least one framing element placed around one or more resilient elements, wherein with reference to a section of the substrate between (a) at least one resilient element framed by the framing element and (b) at least one other resilient element, the said section of the substrate is stretched out to a greater extent than in at least one other section of the substrate in the composite cushioning material, so as to provide a variably tensed composite cushioning material.

These and other objects of the invention will be more fully understood from the following description of the invention, the referenced drawings attached hereto and the claims appended hereto.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIGS. 1A-1B are photographs of embodiments of dual laminate composite.

FIG. 2 is a photograph of an embodiment of alternative second dual laminate composite

FIGS. 3A-3B are partially exploded views of first dual laminate composite.

FIGS. 4A-4B are partially exploded views of alternative first dual laminate composite

FIG. 5 shows a cut sheet of resilient material.

FIG. 6 shows a first substrate layer.

FIG. 7 shows an optional embodiment including perimetral edge material.

FIG. 8 is a partially exploded view showing the lamination of the first substrate layer onto cut sheet of resilient material.

FIG. 9 shows the lamination of the first substrate layer onto cut sheet of resilient material.

FIGS. 10A-10B show laminated resilient material assembly.

FIGS. 11A-11B show the heat-pressing operation that may be optionally utilized to laminate a substrate layer to resilient elements.

FIGS. 12A-12T show various embodiments of framing elements.

FIG. 13 is a photograph of one embodiment of framing element.

FIG. 14 shows laminated resilient material assembly.

FIGS. 15A-15B show first stretched resilient material assembly.

FIGS. 16A-16D show the substrate layer in the stretched resilient material assembly in a stretched out state, with framing element being positioned to engage, and then engaging the resilient elements.

FIGS. 17A-17B show perspective and side views of second stretched resilient material assembly.

FIGS. 18A-18B show perspective and side views of second stretched resilient material assembly, engaging a different framing element.

FIG. 19 is a photograph of an embodiment of first stretched resilient material assembly.

FIG. 20A-20B show first stretched resilient material assembly being returned to a non-stretched state engaging with different framing elements in FIG. 20A and FIG. 20B.

FIG. 21 shows first single laminate composite.

FIG. 22 is a photograph of an embodiment of second single laminate composite.

FIG. 23 shows third single laminate composite.

FIG. 24 is a photograph of an embodiment of fourth single laminate composite.

FIG. 25 shows second substrate layer being positioned next to first single laminate composite.

FIG. 26 shows second substrate layer being positioned closer to first single laminate composite.

FIG. 27 shows first stretched resilient material assembly.

FIG. 28 shows second substrate layer being positioned next to first stretched resilient material assembly.

FIG. 29 is a photograph of second substrate layer positioned next to first single laminate composite.

FIG. 30A-30D the heat-pressing operation that may be optionally utilized to laminate a substrate layer to resilient elements.

FIG. 31 is a photograph of an embodiment of second dual laminate composite.

FIG. 32 is a photograph of an embodiment of second dual laminate composite.

FIG. 33 is a photograph of an embodiment of third dual laminate composite.

FIG. 34 is a photograph of an embodiment of fourth dual laminate composite.

FIG. 35 is a photograph of an embodiment of fifth dual laminate composite.

FIG. 36 is a photograph of an embodiment of fifth dual laminate composite.

FIG. 37 is a photograph of an embodiment of sixth dual laminate composite.

FIG. 38A-38B show a flexible and stretchable assembly, that can be an elbow warmer in FIG. 38A or a padded elbow protector in FIG. 38B.

### DETAILED DESCRIPTION OF THE PREFERRED EMBODIMENTS

In the present application, “a” and “an” are used to refer to both single and a plurality of objects.

### Brief Description of the Variably-Tensed Composite Cushioning Material

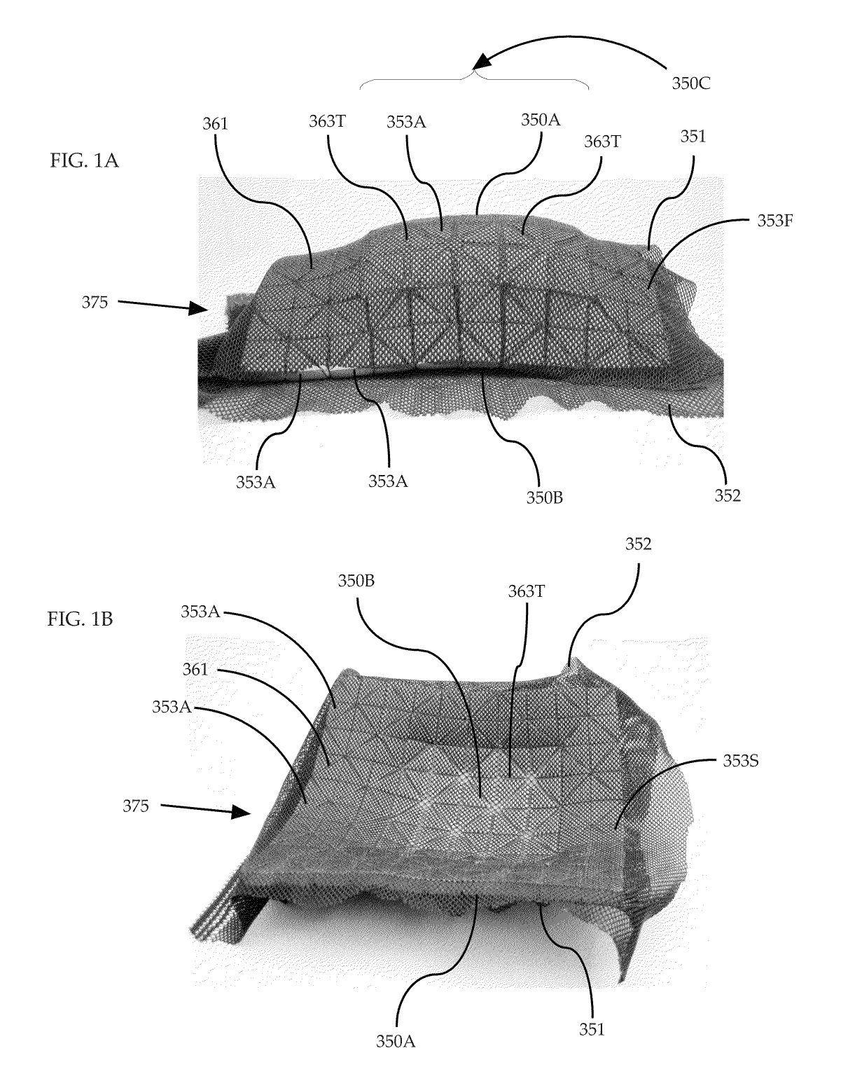

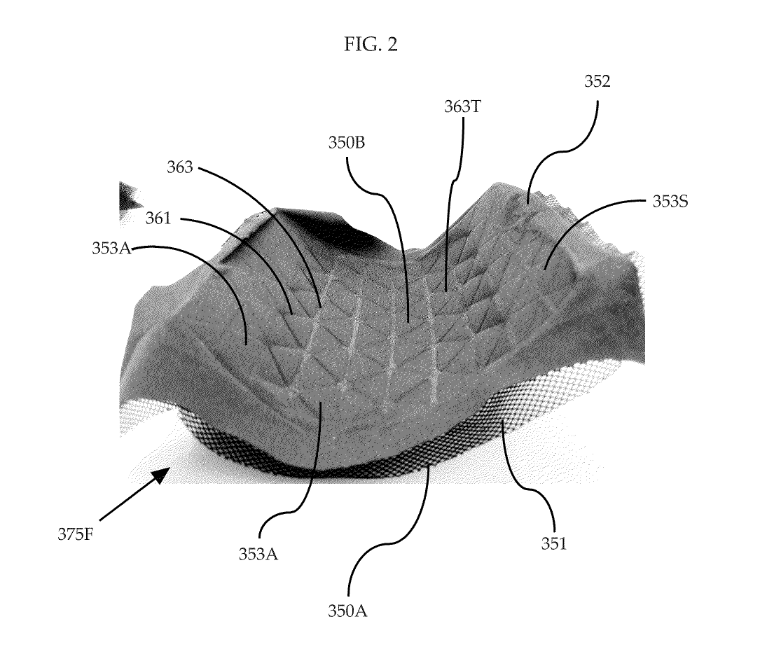

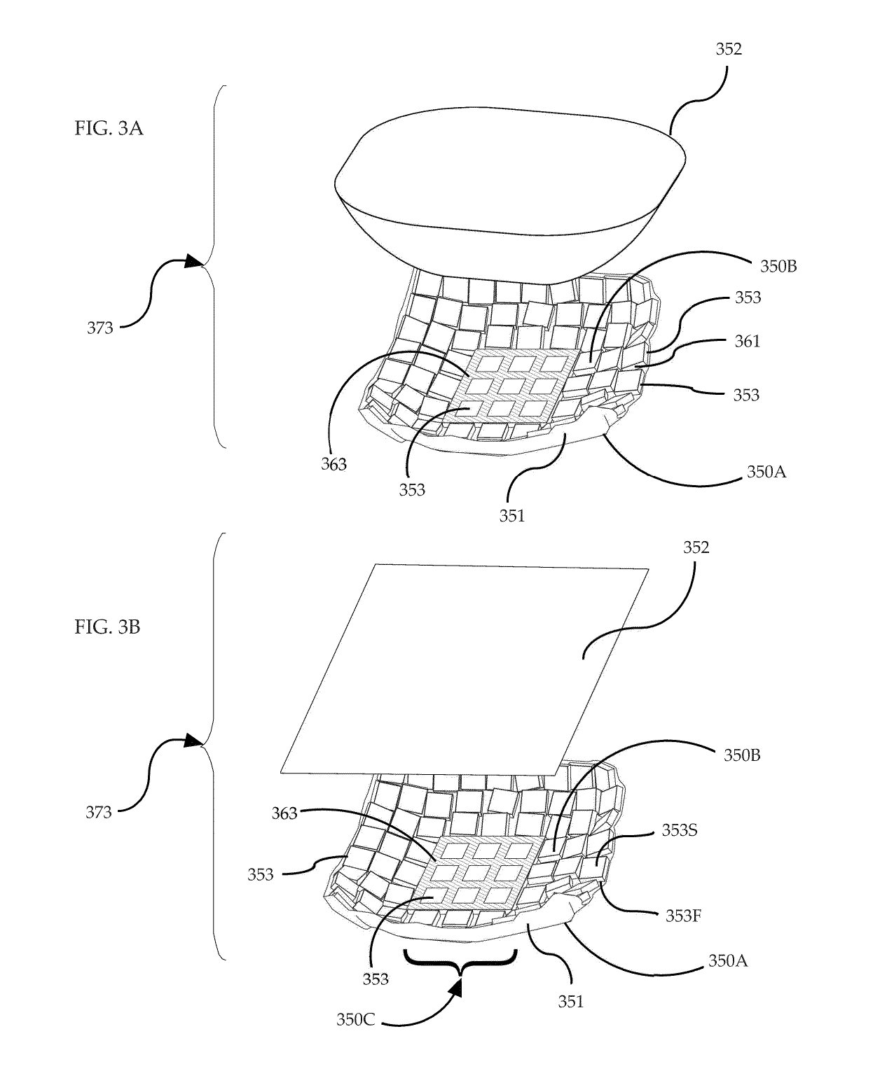

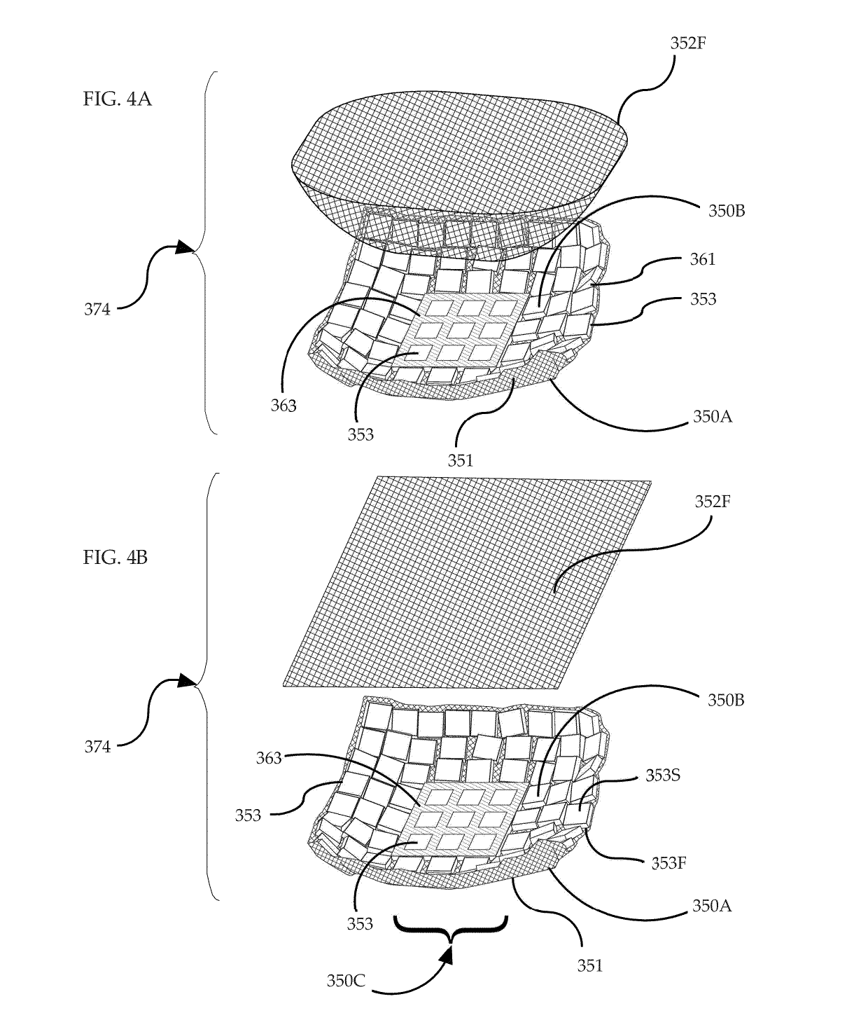

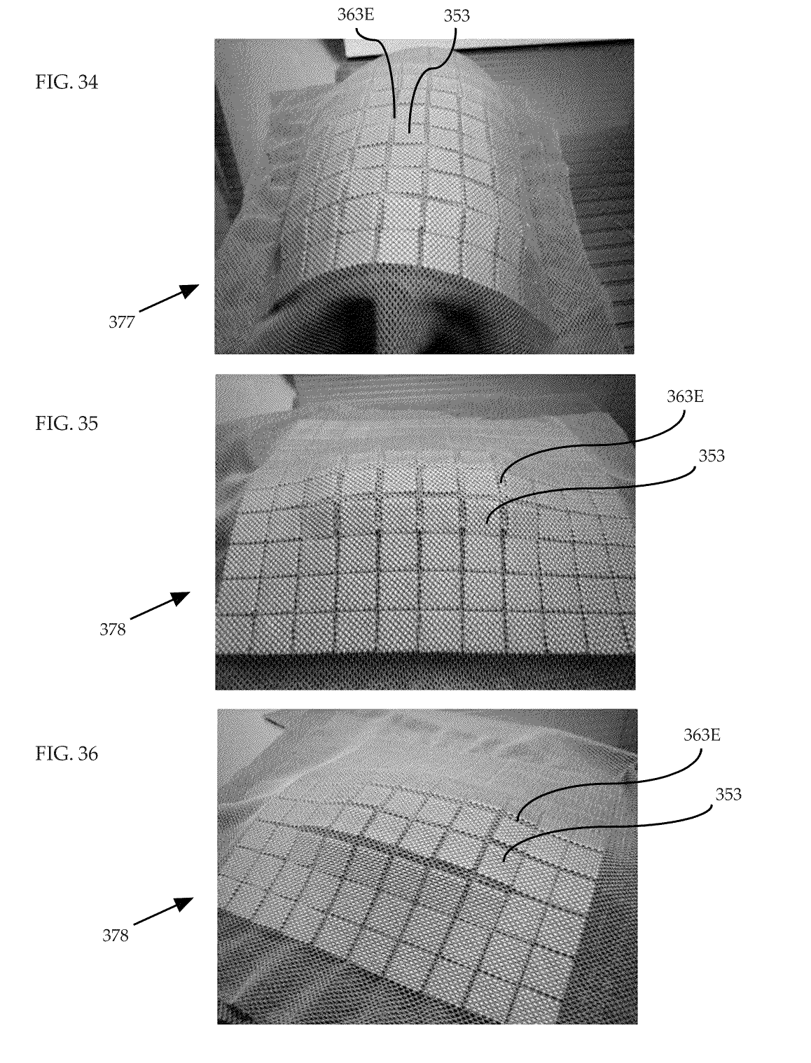

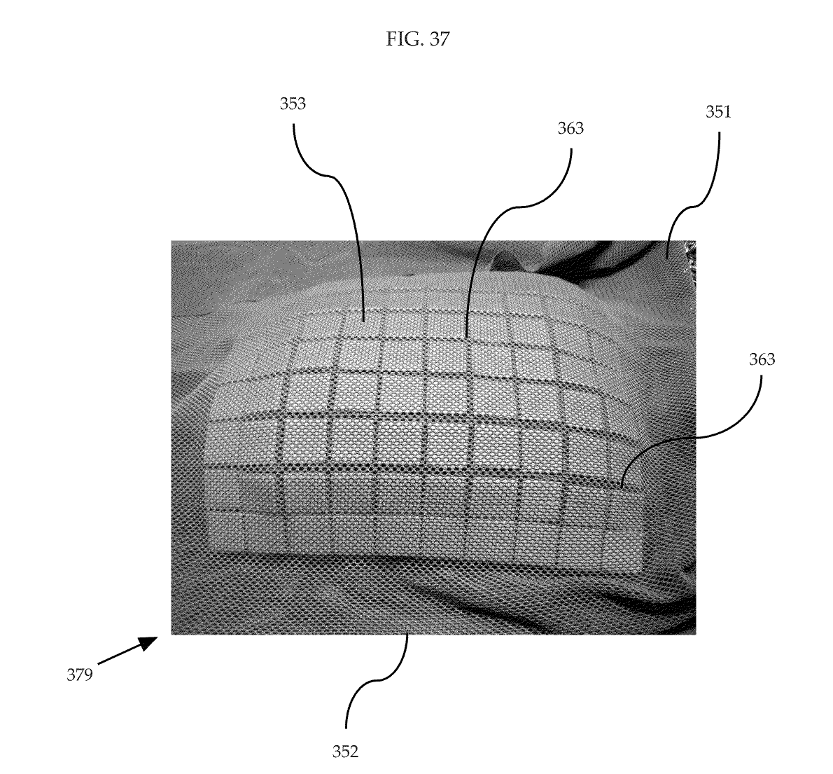

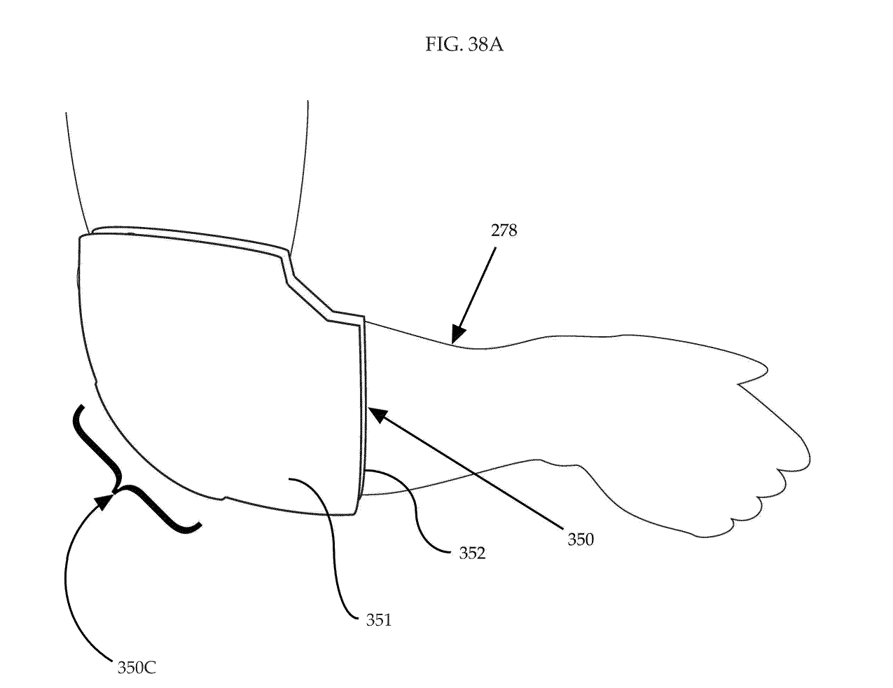

The invention relates to a composite cushioning material comprising a plurality of discrete resilient elements attached or bonded to two substrate layers, wherein the resilient elements are “sandwiched” between the two substrate layers, and the two substrate layers are comprised of one or more flexible and stretchable sheeting materials. Non-limiting examples of such dual laminate composite material include first dual laminate composite 373 depicted in FIGS. 3A and 3B; alternative first dual laminate composite 374 depicted in FIGS. 4A and 4B; second dual laminate composite 375 depicted in FIGS. 1A and 1B, and in 31 and 32; alternative second dual laminate composite 375F depicted in FIG. 2; third dual laminate composite 376 depicted in FIG. 33; fourth dual laminate composite 377 depicted in FIG. 34; fifth dual laminate composite 378 depicted in FIGS. 35 and 36; and sixth dual laminate composite 379 depicted in FIG. 37.

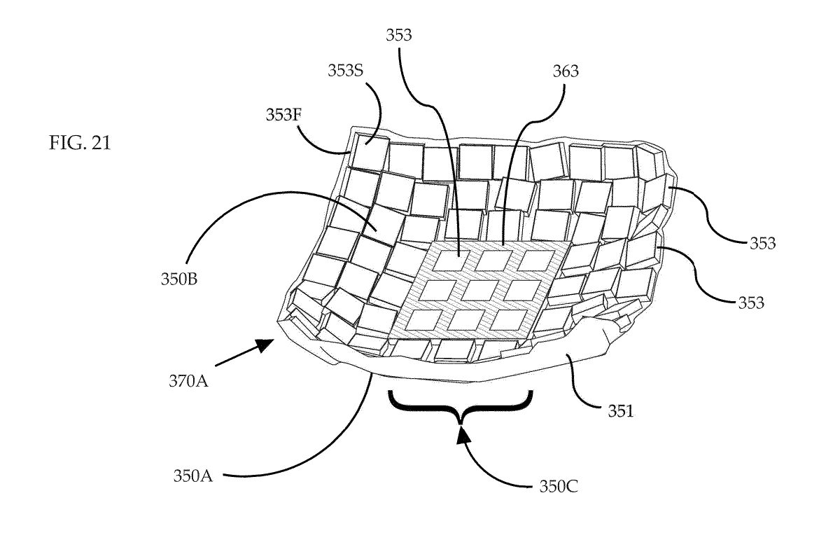

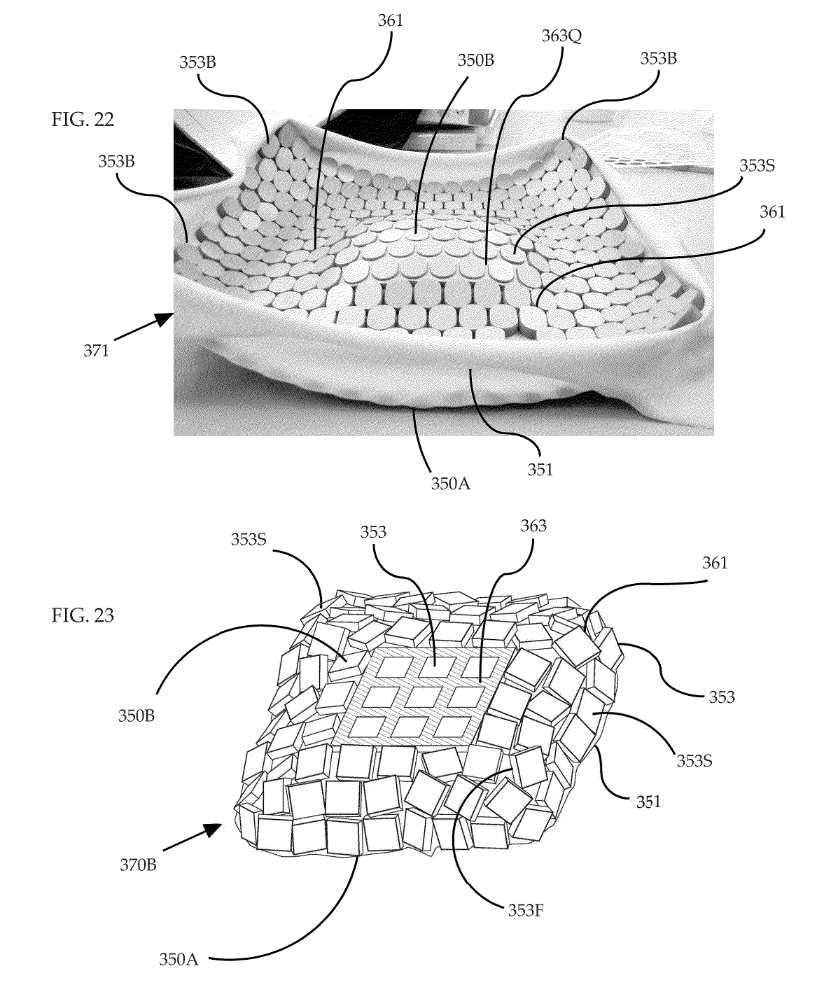

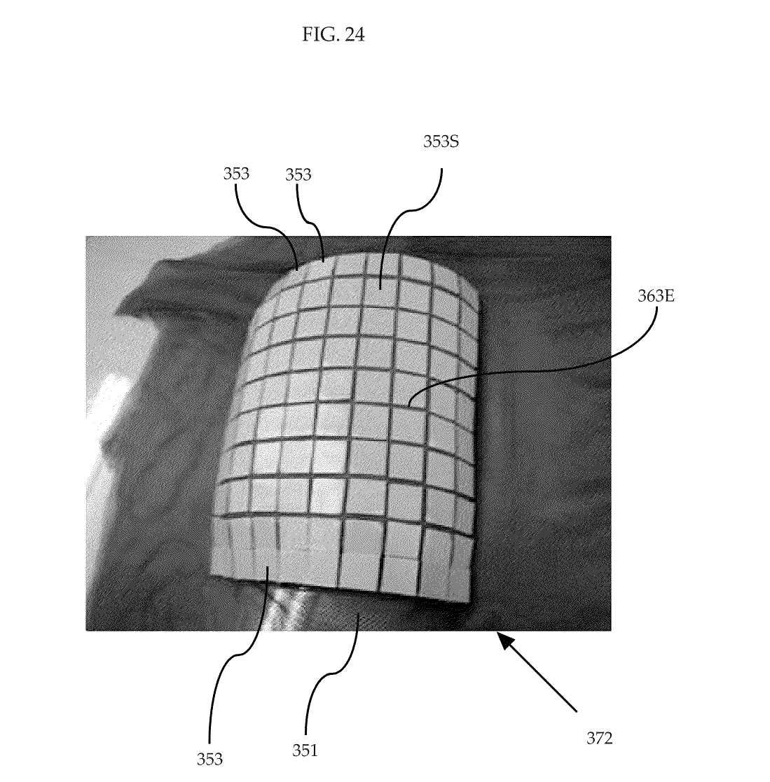

The invention also relates to a composite cushioning material comprising a plurality of discrete resilient elements attached or bonded to a single substrate layer made of a flexible and stretchable sheeting material. Non-limiting examples of such single laminate composite material include first single laminate composite 370A depicted in FIG. 21, second single laminate composite 371 depicted in FIG. 22, third single laminate composite 370B depicted in FIG. 23, and fourth single laminate composite 372 depicted in FIG. 24.

In both types of composite cushioning materials, at least one resilient element is bounded on one or more sides, or surrounded partially or completely, by one or more framing elements. In one embodiment of the invention, the framing elements may optionally include one or more holes or apertures, and one or more resilient elements may optionally be engaged to one or more holes in a framing element, or in multiple framing elements.

In both types of composite cushioning materials (namely, single laminate composite materials such as, by way of example only, single laminate composites 370A-370B, 371, and 372, and dual laminate composite materials such as, by way of example only, and dual laminate composites 373-379), one or more regions or zones of the composite material may optionally have a concave or convex shape. The concave or convex shape permits the composite materials to be used as protective or cushioning materials that better follow the contour of the wearer's body, hand, or foot, or more fully envelop the body parts that are intended to be protected, yet are flexible and breathable.

In one aspect of the invention, the framing elements may optionally be more rigid, less flexible, or less compressible than the substrate layers.

In another aspect of the invention, in the areas or zones of the substrate layer on which one or more resilient elements are bounded by or engaged to a framing element, the substrate layer material is in a relatively more stretched, or “tensed,” state than in the rest of the substrate layer.

In yet another aspect of the invention, a substrate layer to which discrete resilient elements are bonded is mechanically stretched, causing the resilient elements to move apart in relation to each other, and creating spacing between the resilient elements. While the substrate layer is in a stretched state, and the resilient elements bonded to the same have spaced out in relation to each other, one or more framing elements are inserted and fitted into the spacing between the resilient elements, and optionally made to engage one or more resilient elements. The framing elements may optionally be bonded to a substrate layer while the substrate layer is in a stretched state.

After the framing elements have been inserted in place (and may have optionally been bonded to a substrate), the substrate layer as a whole is permitted to return to a non-stretched state, causing the resilient elements to come back together and the spacing between them to decrease. It is understood that the framing elements engaged to one or more resilient elements prevent at least two of the resilient elements from coming back together, even as the substrate layer as a whole returns to a non-stretched state. It is also understood that in the areas, regions, or zones of the substrate layer on which one or more resilient elements are engaged to the framing element, the substrate layer material is prevented from returning to a non-stretched or relaxed state. In those areas, the substrate layer material remains in a relatively more stretched, or “tensed,” state than in the rest of the substrate layer.

Optionally, and alternatively, the framing elements may be bonded to a substrate layer after the substrate layer has returned to a non-stretched, or “relaxed,” state. Or alternatively, the framing elements may optionally be left free, not bonded to a substrate layer.

In one aspect, the invention is drawn to a method of making a composite cushioning material, comprising the following: (1) bonding a plurality of discrete resilient elements to at least one substrate layer; (2) mechanically stretching the substrate layer to which the resilient elements are bonded, and increasing the relative distance between the discrete resilient elements, thereby creating spacing between them; (3) positioning a framing element, which may optionally include holes shaped and sized to engage one or more resilient elements, in proximity with the resilient elements; (4) inserting a framing element between at least two resilient elements, or optionally engaging one or more resilient elements to one or more holes in a framing element; (5) optionally bonding a framing element to the substrate layer; and (6) optionally bonding a second substrate layer to the resilient elements, so that the resilient elements and the framing elements are “sandwiched” between the two sheets of substrate layers.

The various aspects of the invention and the alternative embodiments of the same, and their benefits, will be better appreciated once the composite cushioning material and the various alternative and optional processes of making them, described in greater detail below and depicted in the figures referenced below, are fully understood.

Dual and Single Laminate Variably-Tensed Cushioning Composite Materials

Variably-Tensed Dual Laminate Cushioning Composite

In one aspect, the present invention is drawn to a dual laminate composite material comprising a plurality of discrete resilient elements bonded to two substrate layers, wherein one or more resilient elements may optionally be engaged to one or more framing elements. The resilient elements and the framing elements are “sandwiched” between two substrate layers, and each substrate layer may be bonded to one or more resilient elements.

Various non-limiting examples of dual laminate composites are depicted in FIGS. 1A-1B, 2, 3A-4B, and 31-37.

FIGS. 3A and 3B depict first dual laminate composite 373.

FIGS. 4A and 4B depict alternative first dual laminate composite 374.

FIGS. 1A, 1B, 31, and 32 depict second dual laminate composite 375.

FIG. 2 depict alternative second dual laminate composite 375F.

FIG. 33 depict third dual laminate composite 376.

FIG. 34 depict fourth dual laminate composite 377.

FIGS. 35 and 36 depict fifth dual laminate composite 378.

FIG. 37 depict sixth dual laminate composite 379.

Resilient Element Components

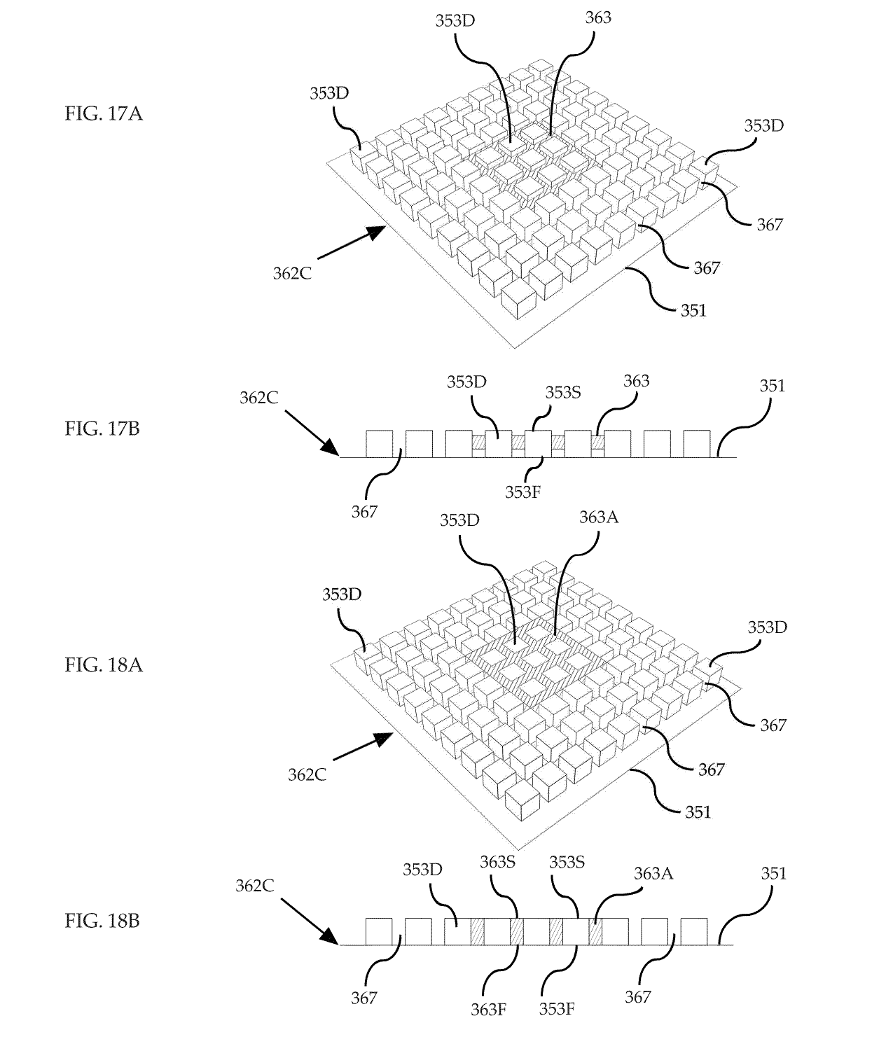

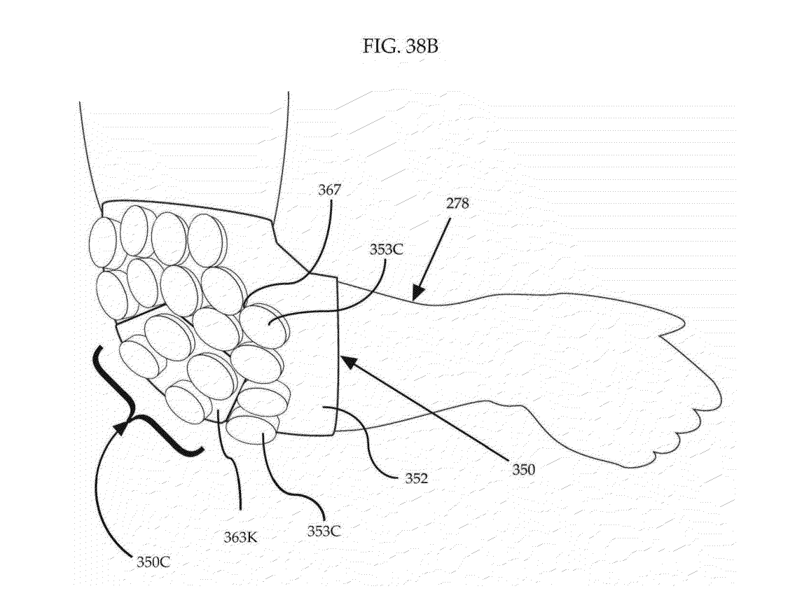

In one aspect of the invention, dual laminate composite materials include a plurality of discrete resilient elements bonded to two substrate layers. Non-limiting examples of the resilient elements include resilient elements 353 depicted in FIGS. 3A and 3B; resilient elements 353A depicted in FIGS. 1A-1B and FIG. 2; resilient elements 353C depicted in FIG. 38B, and resilient elements 353D depicted in FIG. 17A-18B.

It is understood that, optionally, the same resilient elements incorporated into, or used to make, single laminate composites may also be used to make dual laminate composites. Therefore, a dual laminate composite material may optionally incorporate, by way of example only and without limitations, resilient elements 353B depicted in FIG. 22.

By way of illustration, FIGS. 1A and 1B depict a non-limiting example of a dual laminate composite, namely second dual laminate composite 375. FIGS. 3A and 3B, and FIGS. 4A and 4B, depict partially exploded views of other non-limiting examples of a dual laminate composite, namely, first dual laminate composite 373 and alternative first dual laminate composite 374.

As depicted in FIGS. 1A and 1B, second dual laminate composite 375 includes a plurality of discrete resilient elements, namely, resilient elements 353A, that are separated from each other by and along cutting lines 361.

As depicted in FIGS. 3A and 4A, first dual laminate composite 373 and alternative first dual laminate composite 374 also include a plurality of discrete resilient elements, namely, resilient elements 353, that are separated from each other by and along cutting lines 361.

FIGS. 1A and 1B depict resilient elements (namely, resilient elements 353A) that are optionally shaped like triangular solids (namely, triangular prisms). However, it is understood that the resilient elements in a dual laminate composite material may have any suitable shape or dimension, optionally including cubes, cylinders, cuboids, pentagonal prisms, hexagonal prisms, tapered pyramids, and so forth, or a suitable, irregular shape (such as a prism with an irregular cross-section)

By way of example only, in the first dual laminate composite 373 and the alternative first dual laminate composite 374 depicted in FIGS. 3A and 3B and FIGS. 4A and 4B, respectively, the resilient elements (namely, resilient elements 353) are shaped like flattened cubes or square cuboids. Resilient elements may also be optionally shaped like elliptic solids (such as resilient elements 353B shown in FIG. 22), or cylinders (such as resilient elements 353C shown in FIG. 38B), or cubes (such as resilient elements 353D shown in FIG. 17A-18B).

The composition of the resilient elements may include, without limitations, a resilient material such as foam, including ethylene vinyl acetate (“EVA”) foam, olefin or polyolefin foam, polyurethane (“PU”) foam, urethane based foam, or thermoplastic foam, or rubber, elastomer, or other material with suitable shock absorbing characteristics, or resistant to puncture or abrasion (including a combination of any such materials). It is understood that depending on the type and material of which the resilient material is made, functionally the resilient materials may act as a cushion against impact, provide structural rigidity, provide protection against abrasion or puncture, or provide thermal insulation to heat or cold.

As depicted in FIGS. 1A and 1B, a plurality of discrete resilient elements 353 in second dual laminate composite 375 are bonded to two substrate layers, namely, first substrate layer 351 and second substrate layer 352.

As depicted in FIGS. 3A and 4A, a plurality of discrete resilient elements 353 in first dual laminate composite 373 and in alternative first dual laminate composite 374 are also bonded to two substrate layers, namely, first substrate layer 351 and second substrate layer 352.

It is understood that an adhesive is applied to two opposing sides of the resilient elements, in order to bond the resilient elements to the substrate layers. By way of example only, first side 353F of the resilient elements in the dual laminate composite materials depicted in FIG. 1A and in FIGS. 3B and 4B (that is, resilient elements 353A and resilient elements 353, respectively), may be covered with an adhesive or, optionally, a combination of adhesives, that causes the first side 353F of the resilient elements to adhere or bond to the first sheeting structure, such as first substrate layer 351.

Second side 353S of the resilient elements in the dual laminate composite materials depicted in FIG. 1B, and in FIGS. 3B and 4B, may optionally be covered with an adhesive or a combination of adhesives that cause the second side 353S of the resilient elements to adhere or bond to the second sheeting structure, such as second substrate layer 352.

Optionally, adhesive may be applied to first side 353F of one set of resilient elements in a composite material, to second side 353S of a second set of resilient elements, and to both the first side 353F and second 353S of a third set of resilient elements. The three sets of resilient elements may be positioned in a suitable pattern or array, and bonded to first substrate layer 351, second substrate layer 352, or to both substrate layers, depending on whether the resilient elements have adhesive applied on one side (that is, first side 353F), on the other side (that is, second side 353S), or on both sides, provided that at least one resilient element is bonded to two substrate layers.

In one embodiment of the invention, the adhesive applied to the first side 353F of the resilient elements, and to the second side 353S of the resilient elements, is optionally comprised of a hot-melt adhesive (“HMA”) film that is activated by heat, or heat and pressure. Optionally, depending on the type of material and the composition of the resilient elements and the substrate layers, the adhesive may, additionally or alternatively, include ethyl-vinyl acetate, olefin, or polyolefin-based adhesive, glue, or HMA film; polyurethane or urethane based adhesive, glue, or HMA film; or polyamine based adhesive, glue, or HMA film.

However, it is understood that the said adhesive may optionally comprise any glue, bonding agent or compound, adhesive film or laminate, solvent, or tape that permits first side 353F of the resilient elements to bond or adhere to first substrate layer 351. The said adhesive may also be, optionally, any glue, bonding agent or compound, adhesive film or laminate, or tape that permits second side 353S of the resilient elements to bond or adhere to second substrate layer 352. It is also understood that for purposes of this embodiment of the invention, any compound, substance, attachment, or device (including tape, Velcro® or other interlocking mechanical means) suitable for bonding the resilient elements to a substrate layer may be used as an adhesive.

It is further understood that depending on the composition of the first substrate layer 351 and second substrate layer 352, and the composition of the resilient elements, the same or different types of adhesives, or combination of adhesives, may optionally be applied to the first side 353F and second side 353S of the resilient elements.

Framing Element Components

In another aspect of the invention, one or more resilient elements in a dual laminate composite material are bounded on one or more of the sides of the said resilient elements by one or more framing elements, or surrounded partially or completely by one or more framing elements. The framing elements may have a variety of different shapes and dimensions. In one embodiment of the invention, framing elements may be comprised of a lattice of resilient material; alternatively, and optionally, framing elements may also be comprised of “strips” or “bars” of resilient material, or any combinations of “strips” or “bars” and lattices of resilient material. In another embodiment of the invention, framing elements may include one or more holes or apertures, and one or more resilient elements in a dual laminate composite may be engaged to holes in a framing element.

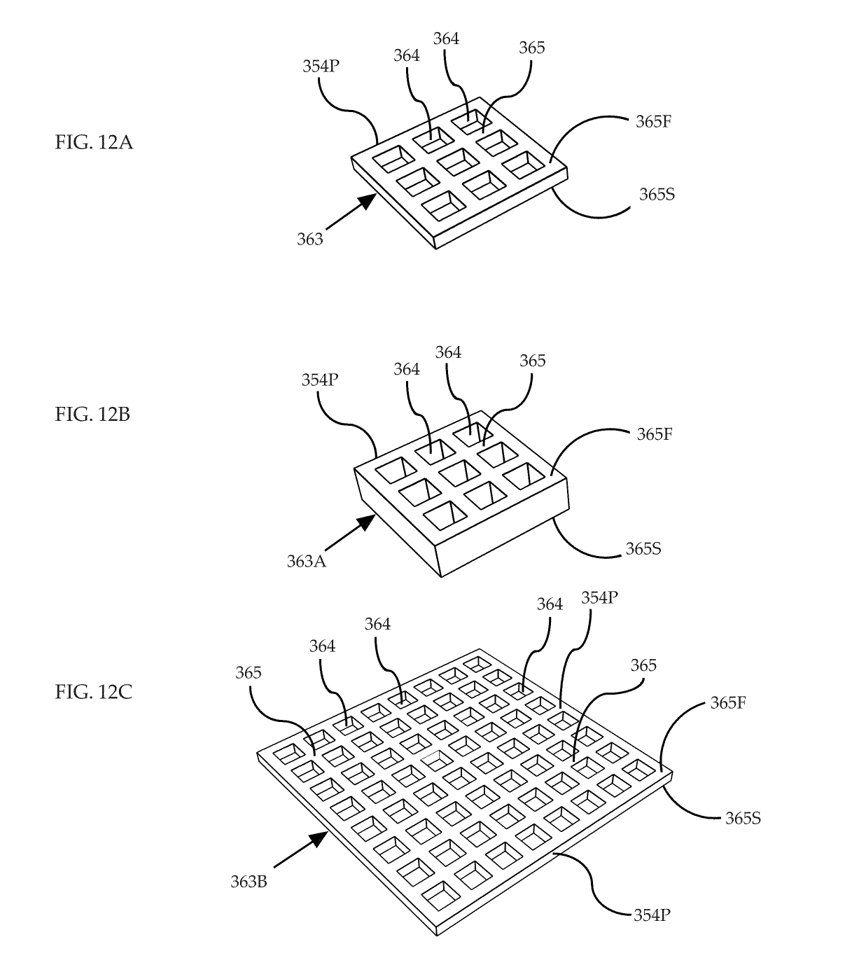

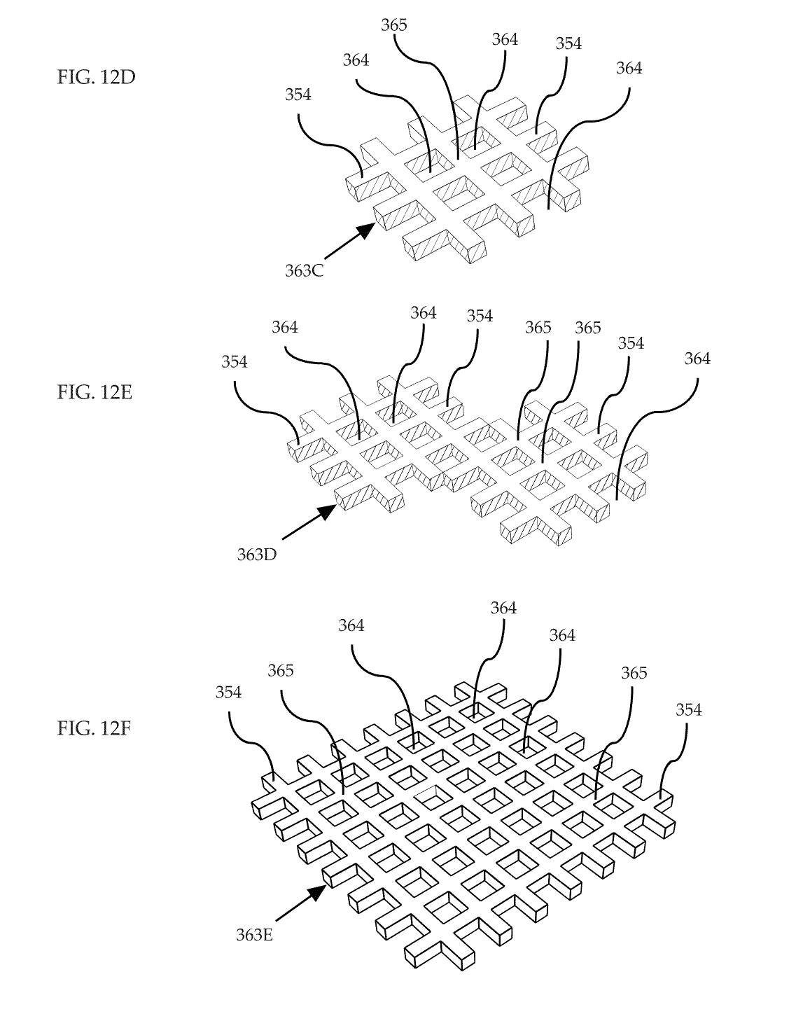

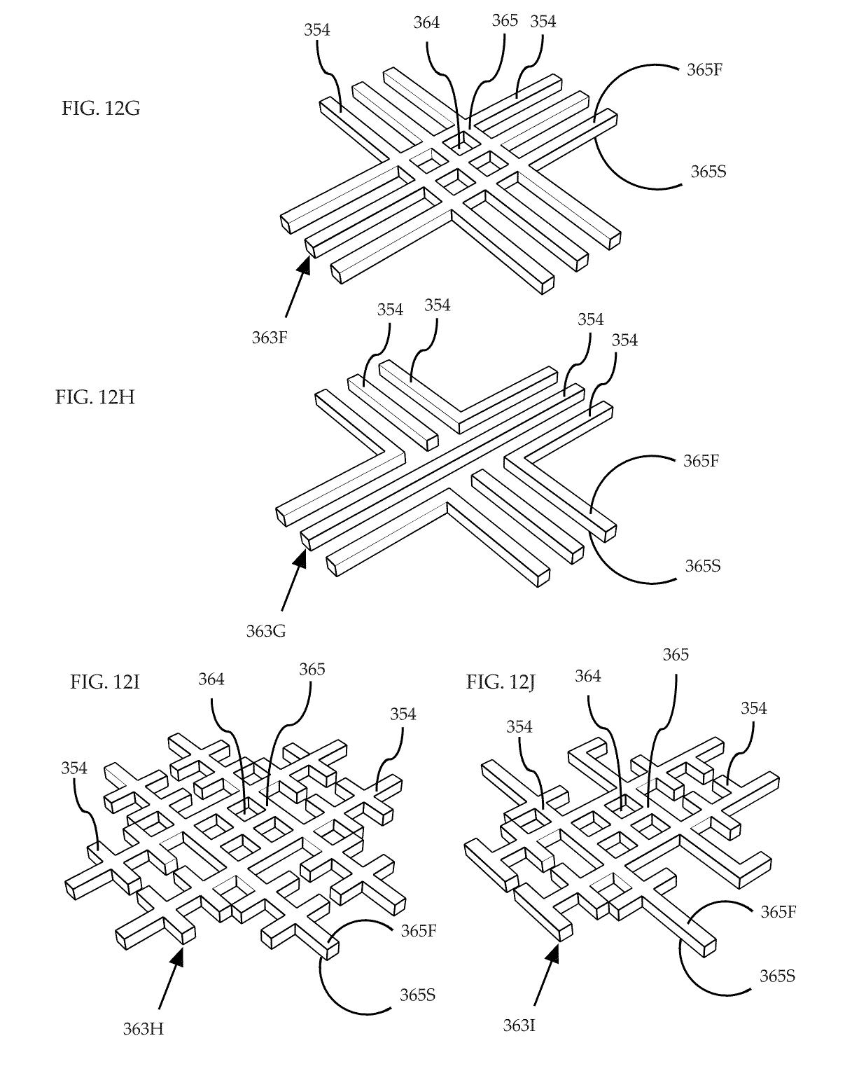

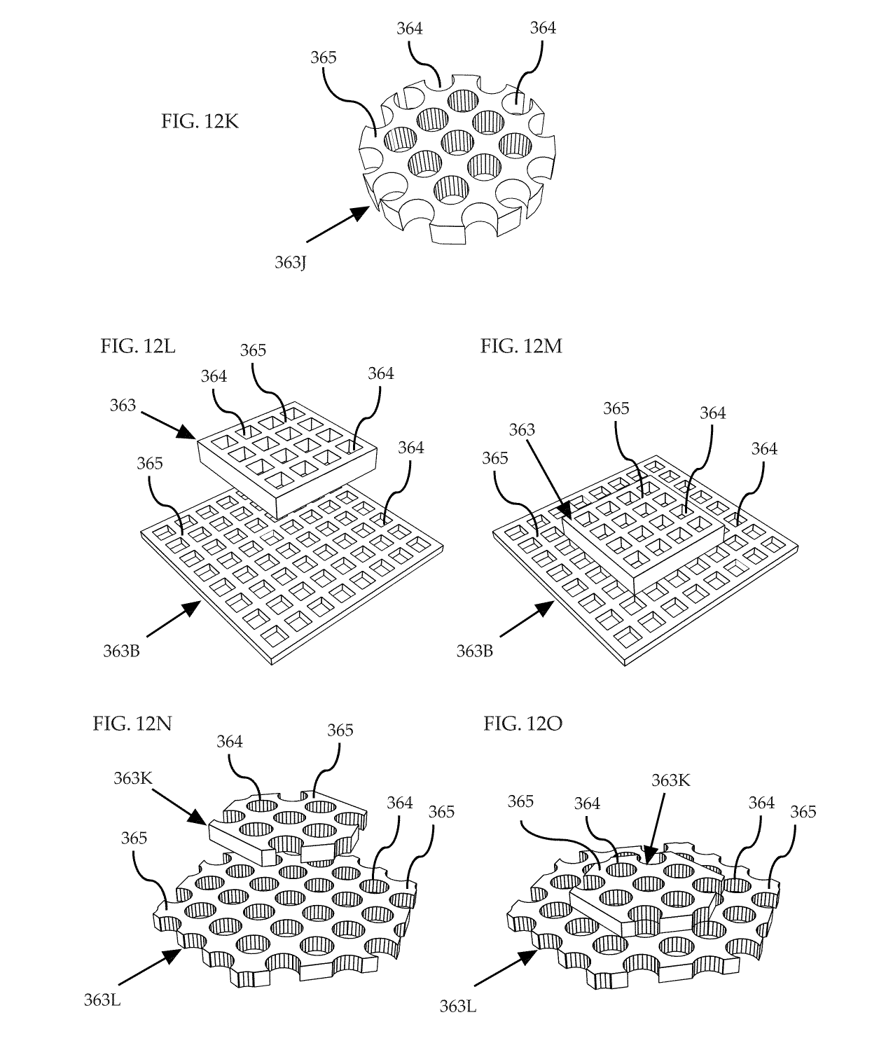

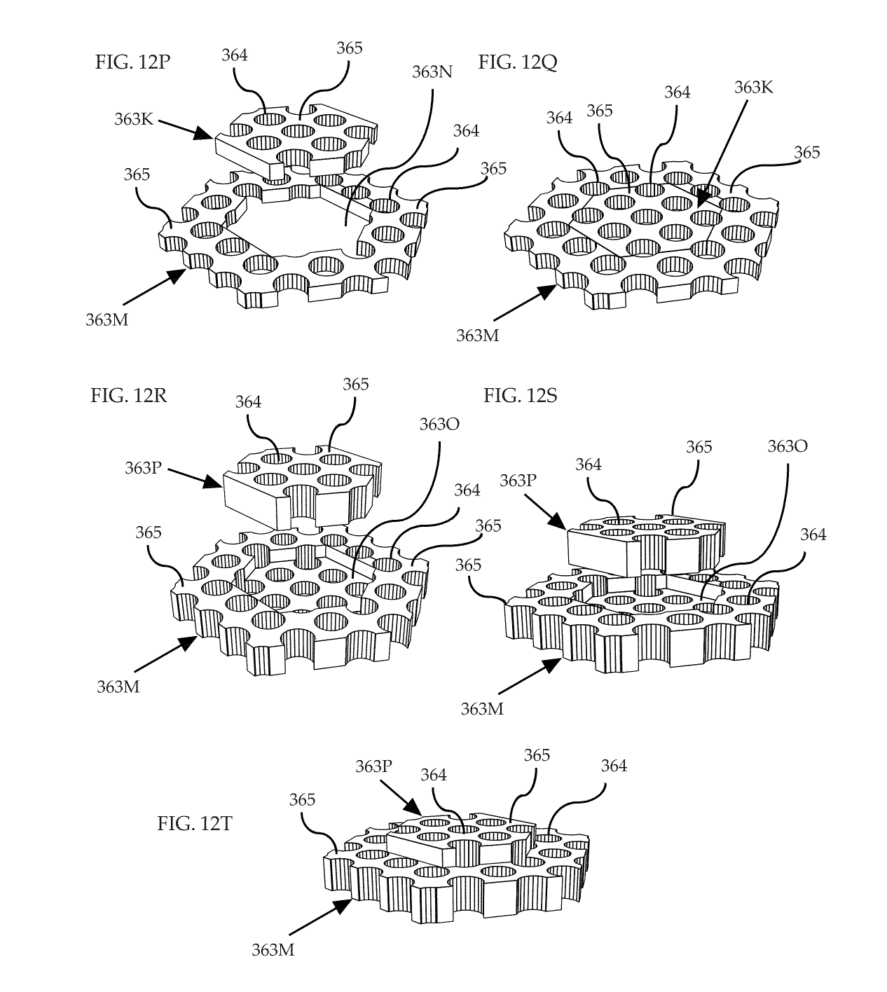

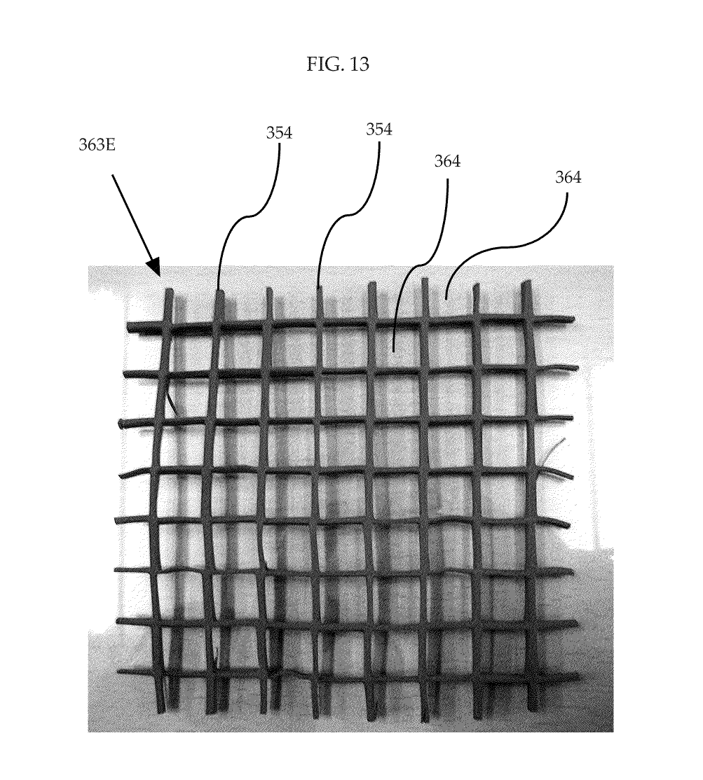

Non-limiting examples of the framing element include framing element 363 depicted by itself in FIG. 12A, and depicted as part of a dual laminate composite in the partially exploded view in FIGS. 3A and 4A; framing element 363T depicted in FIGS. 1A and 1B; framing element 363A depicted in FIG. 12B; framing element 363B depicted in FIG. 12C; framing element 363C depicted in FIG. 12D; framing element 363D depicted in FIG. 12E; framing element 363E depicted in FIGS. 12F and 13; framing element 363F depicted in FIG. 12G; framing element 363G depicted in FIG. 12H; framing element 363H depicted in FIG. 12I; framing element 363I depicted in FIG. 12J; framing element 363J depicted in FIG. 12K; framing element 363K and framing element 363L depicted in FIGS. 12N and 12O; framing element 363M depicted in FIGS. 12P and 12Q; and framing element 363M and framing element 363P depicted in FIGS. 12R-12T.

By way of example only, FIGS. 1A and 1B depict a fully assembled instance of second dual laminate composite 375, which includes a framing element 363T comprising a lattice of resilient material with its outer perimeter shaped like a square. The framing element 363T is positioned and fitted within the dual laminate composite. In this optional embodiment of the invention, framing element 363T includes apertures or holes corresponding to the sizes, shapes, and positions of a plurality of resilient elements 353A in the second dual laminate composite 375. Resilient elements 353A are optionally shaped like triangular prisms; accordingly, framing element 363T comprises a lattice of resilient material with a plurality of triangular apertures or holes. It is understood that the size and shape of the framing element, and the positioning and placement of the framing element in relation to the dual laminate composite, define the variably-tensed zone 350C depicted in FIG. 1A. In this embodiment of the invention, a plurality of resilient elements 353A located within the variably-tensed zone 350C of the second dual laminate composite 375 are optionally engaged to corresponding holes in the framing element 363T.

Another non-limiting example of the placement of the framing element within a dual laminate composite material is more clearly illustrated in FIG. 3A. FIG. 3A depicts a partially exploded view of first dual laminate composite 373, with the second substrate layer 352 partially disassembled and removed from the assembly. As shown in FIG. 3A, framing element 363 may optionally be square in shape, with apertures or holes in the framing element corresponding to the sizes, shapes, and positions of one or more resilient elements 353 in the first dual laminate composite 373. In this optional embodiment of the invention, a plurality of resilient elements 353, but not all of them, are engaged to holes in the framing element 363. As depicted in FIG. 3B, the size, shape, and placement of the framing element 363 within the dual laminate composite defines a variably-tensed zone 350C for that dual laminate composite.

It is understood that in this optional embodiment of the invention, the framing element (namely, framing element 363) does not engage every resilient element (namely, resilient element 353) in the dual laminate composite; however, optionally, a framing element may be dimensioned and shaped so that the framing element engages every resilient element in the dual laminate composite.

In one aspect of the invention, the composition of the framing elements (such as, by way of example only, framing element 363, framing elements 363A-363M, and framing element 363T) may include, without limitations, polymer foam (such as, by way of example only, EVA foam, olefin or polyolefin foam, PU foam, or urethane based foam), thermoplastic or thermoplastic foam, rubber, elastomer, or neoprene, natural leather, synthetic leather, plastic, or rubber (including without limitation, latex, silicone, or synthetic rubber) and so forth, or any combination of such materials.

In one embodiment of the invention, the framing elements may be more rigid, less flexible, or less compressible that the substrate layers. Optionally, the composition of the framing elements may include one or more materials that are more rigid, less flexible, or less compressible than the materials comprising the substrate layers.

It is understood that the framing elements in a dual laminate composite may be made of the same type of material, or combination of materials, in relation to the resilient elements in the said dual laminate composite; alternatively, and optionally, the framing element may be made of a different type of material or combination of materials in relation to the resilient elements. By way of example only, and without limitations, in the first dual laminate composite 373 depicted in FIG. 3A, the resilient elements 353 and the framing element 363 may optionally be made of EVA foam; alternatively, and optionally, the resilient elements 353 may optionally be made of EVA foam, and the framing element 363 may be made of PU foam, neoprene, synthetic leather, rubber, plastic, or other similar material, or an EVA foam material that is softer or more flexible than the EVA foam comprising the resilient elements.

It is understood that the framing element may take on a variety of different and optional shapes, provided that the framing element, or parts thereof, may be lodged or inserted between two or more discrete resilient elements; or the framing element may optionally bound one or more sides of one or more discrete resilient elements; or the framing element may optionally surround, partially or completely, one or more discrete resilient elements in a dual or single laminate composite.

By way of example only, and without limitations, in one embodiment of the invention, the framing element may be comprised of a lattice of resilient material (such as lattice of resilient material 365, depicted in FIGS. 12A-12C, and FIGS. 12L-12T), and it may optionally include one or more holes or apertures (such as holes 364, depicted in FIGS. 12A-12G, FIGS. 12I-12T, and FIG. 13).

Non-limiting examples of such framing elements include framing element 363 depicted in FIG. 12A; framing element 363A depicted in FIG. 12B; framing element 363B depicted in FIG. 12C; framing element 363C depicted in FIG. 12D; framing element 363D depicted in FIG. 12E; framing element 363E depicted in FIGS. 12F and 13; framing element 363F depicted in FIG. 12G; framing element 363H depicted in FIG. 12I; framing element 363I depicted in FIG. 12J; framing element 363J depicted in FIG. 12K; framing element 363K and framing element 363L depicted in FIG. 12N; framing element 363M depicted in FIG. 12P; and framing element 363P depicted in FIG. 12R. It is understood that, optionally, one or more resilient elements in a dual laminate composite may be engaged to one or more holes 364 in the framing element.

Alternatively, and optionally, a framing element may be comprised entirely of “strips” or “bars” of resilient material (such as framing bars 354), such as, by way of example only, framing element 363G depicted in FIG. 12H.

A framing element may also be optionally comprised of a combination of “strips” or “bars” (such as framing bars 354) and lattice structures made of resilient materials. Non-limiting examples of such framing elements include framing element 363C depicted in FIG. 12D; framing element 363D depicted in FIG. 12E; framing element 363E depicted in FIG. 12F; framing element 363F depicted in FIG. 12G; framing element 363H depicted in FIG. 12I; and framing element 363I depicted in FIG. 12J.

It is understood that a framing element may optionally be asymmetrical in shape, such as framing element 363I depicted in FIG. 12J.

In another aspect of the invention, more than one framing element may optionally be incorporated into a dual laminate composite. By way of example only, a plurality of framing elements may optionally be inserted between or among different sets of resilient elements in a dual laminate composite. As a non-limiting example, FIGS. 12P and 12Q depict framing element 363M and framing element 363K, each of them comprised of a lattice of resilient material 365 with a plurality of holes 364 designed to engage the resilient elements that are bonded to a substrate layer. Framing element 363M includes an aperture 363N, and framing element 363K is shaped and sized to fit within the aperture 363N in the framing element 363M, as depicted in FIG. 12Q. It is understood that the framing elements may be positioned so that a plurality of resilient elements in a dual laminate composite may be aligned with holes 364 in the framing elements, and may be engaged to the same.

Optionally, framing element 363K and framing element 363M may be made of different types of material. For example, in one embodiment of the invention, both framing elements are made of EVA foam, but framing element 363K is optionally made of an EVA foam denser or stiffer than the EVA foam that makes up framing element 363M.

In yet another aspect of the invention, a plurality of framing elements may optionally be stacked and fitted together into a dual laminate composite, so that more than one framing element is inserted or lodged between or among the same set of resilient elements, or more than one framing element engages the same set of resilient elements. As a non-limiting example, FIGS. 12L-12M depict framing element 363 and framing element 363B, each of them comprised of a lattice of resilient material 365 with a plurality of holes 364 designed to engage one or more resilient elements bonded to a substrate layer. As depicted in FIG. 12L, framing element 363 is optionally stacked over framing element 363B. The two framing elements are positioned in relation to each other, so that holes 364 in framing element 363 align with the corresponding holes 364 in framing element 363B. A plurality of resilient elements in a dual laminate composite are aligned with the holes in the two framing elements, and the said resilient elements are engaged to the aforementioned holes.

FIGS. 12N-12O depict framing element 363K and framing element 363L, each of them comprised of a lattice of resilient material 365 with a plurality of holes 364, with the holes in the framing element 363K sized and positioned so as to align with the holes in the framing element 363L. As depicted in FIG. 12N, framing element 363K is stacked over framing element 363L. The two framing elements are positioned in relation to each other so that holes 364 in framing element 363K are aligned with the corresponding holes 364 in framing element 363L. A plurality of resilient elements in the dual laminate composite are aligned with the holes in the two framing elements, and the said resilient elements are engaged to the aforementioned holes.

Alternatively, and optionally, FIGS. 12R-12T depict framing element 363P and framing element 363M, each of them comprised of a lattice of resilient material 365 with a plurality of holes 364, with the holes in the framing element 363P sized and positioned so as to align with the holes in the framing element 363M. As shown in FIG. 12R, framing element 363P may be stacked over framing element 363M. As also shown in FIGS. 12S and 12T, Framing element 363P may be shaped and sized to fit within a spacing 363O in the framing element 363M, wherein spacing 363O is dimensioned and shaped so as to accept framing element 363P, as depicted in FIG. 12T. The two framing elements may be positioned in relation to each other so that holes 364 in framing element 363P are aligned with the corresponding holes 364 in framing element 363M. A plurality of resilient elements in the dual laminate composite may be aligned with the holes in the two framing elements, and the said resilient elements may be engaged to the aforementioned holes.

Substrate Layer Components

In another aspect of the invention, a plurality of resilient elements (such as, by way of example only, resilient elements 353, 353A, 353B, and 353C) in the dual laminate composite material are bonded to two sheeting structures, namely first substrate layer 351 and second substrate layer 352.

It is understood that in such dual laminate composites, the resilient elements, and the framing elements that contact or engage one or more of the said resilient elements, are “sandwiched” between the two substrate layers.

Non-limiting examples of the substrate layers (namely, first substrate layer 351 and second substrate layer 352) are shown in FIGS. 3A and 3B. FIGS. 3A and 3B depict a partially exploded view of a dual laminate composite, namely, first dual laminate composite 373. A plurality of discrete resilient elements 353 in the first dual laminate composite 373 are bonded to the first substrate layer 351. Framing element 363 is engaged to several resilient elements 353. In FIGS. 3A and 3B, second substrate layer 352 is shown detached and “lifted” from the assembly; however, this is only for illustrative purposes, and it is understood that second substrate layer 352 is bonded to second side 353S of the resilient elements 353, while first substrate layer 351 is bonded to first side 353F of the resilient elements 353.

As shown in FIG. 3A, first side 350A of the first dual laminate composite 373 is laminated with first substrate layer 351, and second side 350B of the first dual laminate composite 373 is laminated with second substrate layer 352. The partially exploded view in FIG. 3A depicts second substrate layer 352 with a curved shape. However, it is understood that in this embodiment of the invention, second substrate layer 352 is comprised of a flexible material, and that prior to being laminated to the resilient elements in first dual laminate composite 373, second substrate layer 352 is capable of being stretched out flat, as depicted in FIG. 3B.

In one embodiment of the invention, the framing elements (such as, by way of example only, framing element 363) in a dual laminate composite are not bonded to a substrate layer. Optionally, the holes in a framing element may be suitably sized and shaped, so that the framing element is held in place through compression or friction with the resilient elements. However, it is understood that, optionally, one or more framing elements may be bonded to one or more substrate layers in a dual laminate composite (such as, by way of example only, first substrate layer 351, second substrate layer 352, or both of them). This may optionally be accomplished by applying a suitable adhesive to one or more sides of the framing elements facing a substrate layer, so that the framing elements adhere to one or more substrate layers.

It is understood that alternatively, and optionally, a framing element (such as, by way of example only, framing element 363) in a dual laminate composite may be optionally bonded to two substrate layers (namely, first substrate layer 351 and second substrate layer 352), while one or more resilient elements (such as, by way of example only, resilient elements 353) in the dual laminate composite may be bonded to only a single substrate layer (such as first substrate layer 351 or second substrate layer 352), or optionally one or more resilient elements engaged to a framing element may not be bonded to any substrate layer. Also optionally, a framing element (such as, by way of example only, framing element 363) in a dual laminate composite may be bonded to one of the two substrate layers (namely, first substrate layer 351 or second substrate layer 352), while one or more resilient elements (such as, by way of example only, resilient elements 353) may be bonded to the other substrate layer (second substrate layer 352 or first substrate layer 351, as the case may be).

In one aspect of the invention, first dual laminate composite 373 is curved in three dimensions, and it has a convex shape on its first side 350A and a concave shape on its second side 350B, as shown in FIG. 3A. It is understood that by optionally varying the size, shape, and composition of the framing elements and the substrate layers, and the size, shape, and placement of the resilient elements, the resulting dual laminate composite may optionally take on a greater or lesser degree of concavity or convexity, or take on a “half-pipe” shape shown in FIGS. 33 and 34.

It is also understood that the region or zone of the first substrate layer 351 located in the variably-tensed zone 350C shown in FIG. 3B is more stretched out, or “tensed,” in relation to the rest of the first substrate layer 351.

In one optional embodiment of the invention, each substrate layer (namely, first substrate layer 351 and second substrate layer 352) is optionally comprised of a sheet or layer of synthetic, non-woven stretchable fabric such as spandex, or stretchable nylon or polyester mesh. However, it is understood the substrate layer (such as first substrate layer 351 and second substrate layer 352) may optionally be comprised of a sheet or layer of any material that is relatively flexible and stretchable and may be used as a sheeting structure, including, without limitations, natural or synthetic fabric (including, by way of example only and without limitations, polyester, nylon, Lycra®, or elastane), stretchable mesh (including open mesh), flexible or pliable plastic, neoprene, natural leather, synthetic leather, or a sheet of synthetic fiber, or a combination of such materials. Optionally, the substrate layers may also be made of any flexible and stretchable sheet of foam, plastic, latex, silicone, rubber, other rubber-like materials, elastomer, and so forth, including any combination of such materials. By way of example only, and without limitations, the substrate layers may optionally be comprised of any such materials encased in, laminated with, or sandwiched between, sheets of natural or synthetic fabric.

It is understood that a suitable composition for the substrate layers may optionally be selected from a wide variety and range of materials that are flexible and stretchable, provided that the resulting substrate layer may be made to bond to the resilient elements (such as, by way of example only, resilient elements 353, 353A, 353B, and 353C). The selection of material, or combination of materials, for the substrate layers may impart the finished product with different functional characteristics or performance parameters, such as, by way of example only and without limitations, distinct stretchability, breathability, permeability to gases or liquids, absorbency of vapors and liquids, resistance to tear and puncture, protection from corrosion, and the like.

In another embodiment of the invention, first substrate layer 351, second substrate layer 352, or both of them, may optionally be comprised of a material, or combination of materials, that is flexible or stretchable at the time of the lamination of the substrate layers onto the resilient elements, but becomes hard, less flexible, or less stretchable thereafter. It is understood that in this embodiment of the invention, the substrate layers may optionally be hardened, or made less flexible or stretchable, by drying, curing, heating, chemical activation, or irradiation with infrared, microwave, radio frequency waves, and the like, depending on the composition of the substrate layers.

In another aspect of the invention, first substrate layer 351 may be made of the same types of materials as second substrate layer 352; alternatively, and optionally, first substrate layer 351 and second substrate layer 352 may be made of different types of materials.

By way of example only, and without limitations, in the second dual laminate composite 375 depicted in FIGS. 1A and 1B, first substrate layer 351 and second substrate layer 352 are made of open mesh. In the alternative second dual laminate composite 375F depicted in FIG. 2, first substrate layer 351 is made of open mesh, and second substrate layer 352 is made of a sheet of synthetic fabric.

It is understood that any combination or permutation of suitable materials may be selected for the first substrate layer 351 and the second substrate layer 352. It is also understood that depending on the type and material of which the substrate layers are made, functionally the combination substrate layers may provide protection against abrasion or puncture, provide thermal insulation, or permit the finished dual laminate composite material to be breathable or permeable to gases, vapors, or liquids.

By way of example only, and without limitations, first substrate layer 351 in a dual laminate composite may optionally be comprised of open mesh or other fabric permeable to water vapor, and the second substrate layer 352 may optionally be comprised of cotton, felt, or other fabric material capable of absorbing or retaining liquids or condensed humidity.

Alternatively, and optionally, first substrate layer 351 in a dual laminate composite may optionally be comprised of cotton, and the second substrate layer 352 may optionally be comprised of nylon or other synthetic material that permits a layer air to be trapped between the first substrate layer and second substrate layer, and thereby provide thermal insulation.

FIGS. 4A and 4B depict another non-limiting example of a dual laminate composite, namely, alternative first dual laminate composite 374. In this alternative and optional embodiment of the invention, both first substrate layer 351 and second substrate layer 352 are comprised of a flexible and stretchable open mesh material.

FIGS. 4A and 4B depict partially exploded views of the alternative first dual laminate composite 374. First substrate layer 351 is shown bonded to a plurality of discrete resilient elements 353. Framing element 363 is shown engaged to several resilient elements 353 that are attached to the first substrate layer 351. Second substrate layer 352 is shown detached and “lifted” from the assembly; but again, this is for illustrative purposes only, and it is understood that second substrate layer 352 is bonded to second side 353S of the resilient elements 353, while first substrate layer 351 is bonded to first side 353F of the resilient elements 353 in the alternative first dual laminate composite 374.

As shown in FIG. 4A, alternative first laminate composite 374 is curved in three dimensions, namely, it has a convex shape on its first side 350A, and a concave shape on its second side 350B. As also shown in FIG. 4A, first substrate layer 351 faces first side 350A of the alternative first dual laminate composite 374, and second substrate layer 352 faces second side 350B of the alternative first dual laminate composite 374.

FIG. 4A depicts second substrate layer 352 of the alternative first dual laminate composite 374 with a curved shape. However, it is understood that in this embodiment of the invention, second substrate layer 352 is comprised of a flexible mesh material, and that prior to being laminated to the resilient elements in alternative first dual laminate composite 374, second substrate layer 352 is capable of being stretched out flat, as depicted in FIG. 4B.

In the various dual laminate materials depicted in FIGS. 1A and 1B, FIG. 2, and FIGS. 3A-4B, the first substrate layers 351 and second substrate layers 352 are shown as continuous sheeting structures. However, it is understood that such shape is optional, and that first substrate layer 351 and second substrate layer 352 may be comprised of materials cut or shaped in any size, dimension, or shape, including irregular shapes, non-contiguous shapes, or shapes with openings or apertures.

Variably-Tensed Single Laminate Cushioning Composite

In another aspect, the present invention is also drawn to a single laminate composite material comprising a plurality of discrete resilient elements bonded to a single substrate layer, wherein one or more resilient elements may optionally be engaged to one or more framing element. Optionally, one or more framing elements may be bonded to the substrate layer.

Various non-limiting examples of single laminate composites are depicted in FIGS. 21-24.

FIG. 21 depicts a non-limiting example of a single laminate composite, namely, first single laminate composite 370A.

It is understood that in one embodiment of the invention, first single laminate composite 370A may include the same components as first dual laminate composite 373 depicted in FIGS. 3A and 3B, except for the following: Optionally, second side 353S of resilient elements 353 is not covered with an adhesive, and a second substrate layer 352 is not bonded to resilient elements 353.

FIG. 22 depicts another non-limiting example of a single laminate composite, namely, second single laminate composite 371.

FIG. 23 depicts another non-limiting example of a single laminate composite, namely, third single laminate composite 370B.

It is understood that in one embodiment of the invention, third single laminate composite 370B may include the same components as first dual laminate composite 373 depicted in FIGS. 3A and 3B, except for the following: Optionally, second side 353S of resilient elements 353 is not covered with an adhesive; a second substrate layer 352 is not bonded to resilient elements 353; and the third single laminate composite 370B may optionally have a concave shape on its first side 350A, and a convex shape on its second side 350B.

FIG. 24 depicts another non-limiting example of a single laminate composite, namely, fourth single laminate composite 372.

It is understood that in one embodiment of the invention, fourth single laminate composite 372 may include the same components as first dual laminate composite 373 depicted in FIGS. 3A and 3B, except for the following: Optionally, a plurality of resilient elements 353 are engaged to framing element 363E, instead of framing element 363; framing element 363E is larger in size than framing element 363; second side 353S of resilient elements 353 is not covered with an adhesive; a second substrate layer 352 is not bonded to resilient elements 353; the fourth single laminate composite 372 may optionally have a concave shape on its first side 350A, and a convex shape on its second side 350B; and the finished single laminate composite, as a whole, is shaped like a “half-pipe,” as depicted in FIG. 24.

Resilient Element Components

In one aspect of the invention, single laminate composite materials include a plurality of discrete resilient elements bonded to a single substrate layer. Non-limiting examples of such resilient elements include resilient elements 353 depicted in FIGS. 21, 23, and 24; and resilient elements 353B depicted in FIG. 22.

It is understood that, optionally, the same resilient elements used to make dual laminate composites may also be used to make single laminate composites. Therefore, a single laminate composite material may optionally incorporate, by way of example only and without limitations, resilient elements 353 depicted in FIGS. 3A and 3B; resilient elements 353A, depicted in FIGS. 1A-1B and FIG. 2; and resilient elements 353C depicted in FIG. 38B.

As depicted in FIG. 21, first single laminate composite 370A includes a plurality of discrete resilient elements, namely, resilient elements 353, bonded to a substrate layer, namely, first substrate layer 351.

As depicted in FIG. 23, third single laminate composite 370B also includes a plurality of discrete resilient elements, namely, resilient elements 353, bonded to a substrate layer, namely, first substrate layer 351.

FIGS. 21 and 23 depict resilient elements (namely, resilient elements 353) that are optionally shaped like square cuboids. However, it is understood that the resilient elements in a single laminate composite material may be of any suitable shape, including optionally cylinders, cubes, triangular prisms, hexagonal prisms, tapered pyramids, and so forth. By way of example only, and without limitations, FIG. 22 depicts resilient elements (namely, resilient elements 353B that are shaped like elliptic cylinders) bonded to a substrate layer in second single laminate composite 371.

As pointed out above, it is understood that the resilient elements may be made from a wide variety and range of resilient materials, including, without limitations, EVA foam, olefin or polyolefin foam, PU foam, urethane based foam, thermoplastic foam, or other polymer foam, rubber, elastomer, or other material with suitable shock absorbing characteristics, or resistant to puncture or abrasion. It is also understood that the resilient elements may be made of a combination of any such materials. By way of example only, resilient elements may be comprised of two or more layers of materials (such as a soft EVA foam layer, and a harder PU foam layer) bonded together.

It is understood that an adhesive is applied to the side of the resilient elements facing the substrate layer, in order to bond the resilient elements to the substrate layer. By way of example only, first side 353F of the resilient elements 353 in the single laminate composite materials depicted in FIGS. 21 and 23 (that is, first single laminate composite 370A and third single laminate composite 370B, respectively) is covered with an adhesive or, optionally, a combination of adhesives, that causes the first side 353F of the resilient elements to adhere or bond to a sheeting structure, such as first substrate layer 351.

It is also understood that second sides 353S of the resilient elements in a single laminate composite material (such as, by way of example only, first single laminate composite 370A and third single laminate composite 370B depicted in FIGS. 21 and 23, respectively) need not be covered with an adhesive, and second side 353S may optionally be left in its original, exposed state.

It is further understood that in one embodiment of the invention, the adhesive applied to the first side 353F of the resilient elements is optionally comprised of an HMA film that is activated by heat, or heat and pressure. Optionally, depending on the type of material and the composition of the resilient elements and the substrate layer, the adhesive may, additionally or alternatively, include ethyl-vinyl acetate, olefin, or polyolefin-based adhesive, glue, or HMA film; polyurethane or urethane based adhesive, glue, or HMA film; or polyamine based adhesive, glue, or HMA film.

The adhesive applied to first side 353F of the resilient elements in a single laminate composite material may optionally comprise any glue, bonding agent or compound, adhesive film or laminate, solvent, or tape that permits first side 353F of the resilient elements (such as, by way of example only, resilient elements 353, resilient elements 353S, and the like) to bond or adhere to the substrate layer (such as first substrate layer 351). For purposes of this embodiment of the invention, any compound, substance, attachment, or device (including tape, Velcro® or other interlocking mechanical means) suitable for bonding the resilient elements to the substrate layers may be used as an adhesive. Optionally, the same adhesive or combination of adhesives used to assemble dual laminate composite materials may optionally be used to assemble single laminate composite materials.

It is further understood that depending on the composition of the first substrate layer 351 and second substrate layer 352, and the composition of the resilient elements, the same types of adhesives, or combination of adhesives, used to bond the resilient elements to the first substrate layer 351 or second substrate layer 352 in a double laminate composite material may be used to bond the resilient elements to a substrate layer in a single laminate composite material.

Framing Element Components

In another aspect of the invention, one or more resilient elements in the single laminate composite materials may be bounded on one or more of the sides of the said resilient elements by one or more framing elements; and optionally, one or more resilient elements may be surrounded partially or completely by one or more framing elements. It is understood that the framing elements may have a variety of different shapes. By way of example only, and without limitations, a framing element may optionally be comprised of a lattice of a resilient material, or “strips” or “bars” of resilient materials, or any combinations of the same. It is also understood that a framing elements may include one or more holes or apertures, and one or more resilient elements in a single laminate composite may be engaged to one or more holes in the framing element.

Non-limiting examples of the framing elements that may be incorporated into a single laminate composite include, by way of example only and without limitations, framing element 363 (depicted in FIG. 12A); framing element 363T (depicted in FIGS. 1A and 1B); framing element 363A (depicted in FIG. 12B); framing element 363B (depicted in FIG. 12C); framing element 363C (depicted in FIG. 12D); framing element 363D (depicted in FIG. 12E); framing element 363E (depicted in FIGS. 12F and 13); framing element 363F (depicted in FIG. 12G); framing element 363G (depicted in FIG. 12H); framing element 363H (depicted in FIG. 12I); framing element 363I (depicted in FIG. 12J); framing element 363J (depicted in FIG. 12K); framing element 363K and framing element 363L (depicted in FIGS. 12N and 12O); framing element 363M (depicted in FIGS. 12P and 12Q); and framing element 363M and framing element 363P (depicted in FIGS. 12R-12T).

By way of example only, FIG. 21 depicts first single laminate composite 370A, with a framing element 363 comprising a lattice of resilient material with its outer perimeter optionally shaped like a square. In this optional embodiment of the invention, framing element 363 includes apertures or holes corresponding to the sizes, shapes, and positions of a plurality of resilient elements 353 in the single laminate composite, which resilient elements are bonded to first substrate layer 351. Resilient elements 353 are optionally shaped like square cuboids; accordingly, framing element 363 comprises a lattice of resilient material with a plurality of square apertures or holes. It is understood that the size and shape of the framing element, and the positioning and placement of the framing element in relation to the single laminate composite, define the variably-tensed zone 350C depicted in FIG. 21. In this optional embodiment of the invention, a plurality of resilient elements 353 in the single laminate composite, but not all of them, are engaged to the apertures or holes in the framing element 363; as depicted in FIG. 21, only those resilient elements 353 located within the variably-tensed zone 350C of the first single laminate composite 370A are engaged to the corresponding holes in the framing element 363.

However, optionally, one or more framing elements may be dimensioned and shaped so that one or more framing elements, individually or together, engage every resilient element in a single or dual laminate composite.

The composition of the framing elements in a single laminate composite may optionally include, by way of example only and without limitations, polymer foam (such as, by way of example only, EVA foam, olefin or polyolefin foam, PU foam, or urethane based foam), thermoplastic or thermoplastic foam, rubber, elastomer, or neoprene, natural leather, synthetic leather, plastic, or rubber (including without limitation, latex, silicone, or synthetic rubber) and so forth, or any combination of such materials.

In one embodiment of the invention, the framing elements may be more rigid, less flexible, or less compressible that the substrate layers. Optionally, the composition of the framing elements may include one or more materials that are more rigid, less flexible, or less compressible than the materials comprising the substrate layers.

It is understood that, optionally, the same framing element, or combination of framing elements, used to make a dual laminate composite may also be used to make a single laminate composite. It is also understood that the same composition of materials in the framing elements incorporated into a dual laminate composite may optionally be used to make the framing elements incorporated into a single laminate composite.

It is further understood that the framing elements in a single laminate composite may be made of the same type of material, or combination of materials, in relation to the resilient elements in the said single laminate composite; alternatively, and optionally, the framing element may be made of a different type of material or combination of materials in relation to the resilient elements. By way of example only, and without limitations, in the first single laminate composite 370A depicted in FIG. 21, the resilient elements 353 and the framing element 363 may optionally be made of EVA foam; alternatively, and optionally, the resilient elements 353 may optionally be made of EVA foam, and the framing element 363 may be made of PU foam, neoprene, synthetic leather, rubber, plastic, or other similar material, or an EVA foam material that is softer or more flexible, or optionally harder or more rigid, than the EVA foam comprising the resilient elements.

The framing element may optionally take on a variety of different shapes and dimensions, provided that the framing element or parts thereof may be lodged between two or more discrete resilient elements; or the framing element optionally bounds one or more sides of one or more discrete resilient element; or the framing element optionally surrounds, partially or completely, one or more resilient elements in a single laminate composite.

By way of example only, and without limitations, in one embodiment of the invention, a framing element may be comprised of a lattice of resilient material (such as lattice of resilient material 365, depicted in FIGS. 12A-12C, and FIGS. 12L-12T), and the framing element may optionally include one or more holes or apertures (such as holes 364, depicted in FIGS. 12A-12G, FIGS. 12I-12T, and FIG. 13). Non-limiting examples of such framing elements include, by way of example only and without limitations, framing element 363 depicted in FIG. 12A; framing element 363A depicted in FIG. 12B; framing element 363B depicted in FIG. 12C; framing element 363C depicted in FIG. 12D; framing element 363D depicted in FIG. 12E; framing element 363E depicted in FIGS. 12F and 13; framing element 363F depicted in FIG. 12G; framing element 363H depicted in FIG. 12I; framing element 363I depicted in FIG. 12J; framing element 363J depicted in FIG. 12K; framing element 363K and framing element 363L depicted in FIG. 12N; framing element 363M depicted in FIG. 12P; and framing element 363P depicted in FIG. 12R. It is understood that, optionally, one or more resilient elements in a single laminate composite may be engaged to one or more holes 364 in the framing element.

Alternatively, and optionally, a framing element may be comprised entirely of “strips” or “bars” of resilient material (such as framing bars 354), such as, by way of example only, framing element 363G.

A framing element may also be optionally comprised of a combination of “strips” or “bars” (such as framing bars 354) and lattice structures made of resilient material, such as, by way of example only, framing element 363C, framing element 363D depicted in FIG. 12E; framing element 363E depicted in FIG. 12F; framing element 363F depicted in FIG. 12G; framing element 363H depicted in FIG. 12I; and framing element 363I depicted in FIG. 12J.

It is understood that a framing element may optionally be asymmetrical in shape, such as framing element 363I depicted in FIG. 12J.

It is understood that more than one framing element may optionally be incorporated into a single laminate composite, as depicted by way of example only in FIGS. 12P and 12Q (depicting framing element 363M and framing element 363K); FIGS. 12L and 12M (depicting framing element 363 and framing element 363B); FIGS. 12N and 12O (depicting framing element 363K and framing element 363L); and FIGS. 12R-12T (depicting framing element 363P and framing element 363M).

Substrate Layer Components

In another aspect of the invention, a plurality of resilient elements in the single laminate composite material (such as, by way of example only, resilient elements 353, 353A, 353B, and 353C) are bonded to a sheeting structure, such as first substrate layer 351.

Non-limiting examples of such sheeting structure or substrate layer (namely, first substrate layer 351) incorporated into single laminate composite materials are shown in FIGS. 21 and 23. FIGS. 21 and 23 depict first single laminate composite 370A and third single laminate composite 370B, respectively. In both instances, a plurality of discrete resilient elements 353 are bonded to first substrate layer 351, wherein first side 353F of the resilient elements 353 face and contact the first substrate layer 351. FIGS. 21 and 23 also depict framing element 363 engaged to a plurality of resilient elements 353.

In one embodiment of the invention, one or more framing elements (such as, by way of example only, framing element 363) in a single laminate composite (such as, by way of example only, first single laminate composite 370A shown in FIG. 21) may optionally be bonded to the substrate layer (such as first substrate layer 351). This may be accomplished by optionally applying a suitable adhesive to the surface of the framing elements facing the substrate layer, so that the framing elements adhere to the substrate layer. However, it is understood that, alternatively and optionally, the framing elements need not be bonded to the substrate layer. Optionally, the holes in the framing elements may be suitably sized and shaped, so that the framing elements may be held in place through compression or friction with the resilient elements.

As shown in FIG. 21, first single laminate composite 370A is curved in three dimensions, and it has a convex shape on its first side 350A, and a concave shape on its second side 350B. It is understood that in this embodiment of the invention, the portion of the first substrate layer 351 located in the variably-tensed zone 350C depicted in FIG. 21 is more stretched out in relation to the rest of the first substrate layer 351.

As shown in FIG. 23, third single laminate composite 370B is also curved in three dimensions, but it has a concave shape on its first side 350A, and a convex shape on its second side 350B. It is understood that in this embodiment of the invention, the portion of the first substrate layer 351 located beneath the framing element 363, and in the areas between the resilient elements 353 framed by the framing element 363, is more stretched out in relation to the rest of the first substrate layer 351. In one embodiment of the invention, framing element 363 in the third single laminate composite 370B is optionally bonded to the first substrate layer 351.

Another non-limiting example of a substrate layer (namely, first substrate layer 351) incorporated into a single laminate composite material is shown in FIG. 22. FIG. 22 depicts second single laminate composite 371. A plurality of discrete resilient elements 353B, which are elliptic cylinders in shape, are bonded to a single substrate layer, namely first substrate layer 351. It is understood that second side 353S of the resilient elements 353B is not bonded to a substrate layer. A framing element 363Q, which includes elliptical holes that are sized and shaped to accept resilient elements 353B, is engaged to a plurality of resilient elements 353B. In one embodiment of the invention, framing element 363Q is optionally bonded to the first substrate layer 351.

As shown in FIG. 22, second single laminate composite 371 is curved in three dimensions, and it has a concave shape on its first side 350A, and a convex shape on its second side 350B. It is understood that in this embodiment of the invention, the portion of the first substrate layer 351 located beneath the framing element 363Q, and in the areas between the resilient elements 353B framed by the framing element 363Q, is more stretched out in relation to the rest of the first substrate layer 351.

It is also understood that by optionally varying the size, shape, and composition of the framing elements and the substrate layers in a single laminate composite material, and the size, shape, and placement of the resilient elements, the resulting single laminate composite may optionally take on a greater or lesser degree of concavity or convexity, or a “half-pipe” shape shown in FIG. 24.

In one optional embodiment of the invention, the substrate layer in a single laminate composite (namely, the first substrate layer 351) is optionally comprised of a sheet or layer of synthetic, non-woven stretchable fabric such as spandex, or stretchable nylon or polyester mesh. However, it is understood that the substrate layer may optionally be comprised of a sheet or layer of any material that is relatively flexible and stretchable and may be used as a sheeting structure, including, without limitations, natural or synthetic fabric (including, by way of example only and without limitations, polyester, nylon, Lycra®, or elastane), stretchable mesh (including open mesh), flexible or pliable plastic, neoprene, natural leather, synthetic leather, or a sheet of synthetic fiber, or a combination of such materials. Optionally, the substrate layer may also be made of any flexible and stretchable sheet of foam, plastic, latex, silicone, rubber, other rubber-like materials, elastomer, and so forth, including any combination of such materials. By way of example only, and without limitations, the substrate layer may optionally be comprised of any such materials encased in, laminated with, or sandwiched between sheets of natural or synthetic fabric.

It is understood that a suitable composition for the substrate layer may optionally be selected from a wide variety and range of materials that are flexible and stretchable, provided that the resulting substrate layer may be made to bond to the resilient elements (such as, by way of example only, resilient elements 353, 353A, 353B, and 353C).

In another embodiment of the invention, first substrate layer 351 may optionally be comprised of a material, or combination of materials, that is flexible or stretchable at the time of the lamination of the substrate layer onto the resilient elements, but becomes hard, less flexible, or less stretchable thereafter. It is understood that in this embodiment of the invention, the substrate layer may optionally be hardened, or made less flexible or stretchable, by drying, curing, heating, chemical activation, or irradiation with infrared, microwave, radio frequency waves, and the like, depending on the composition of the substrate layers.

In another aspect of the invention, the first substrate layer 351 in a single laminate composite may be made of the same type of material, or combination of materials, used to make the first substrate layer 351 or second substrate layer 352 in a dual laminate composite.

It is understood that the first substrate layer 351 in a single laminate composite does not need to be comprised of a continuous sheeting structure, and that first substrate layer 351 may optionally be comprised of materials cut or shaped in any size, dimension, or shape, including irregular shapes, non-contiguous shapes, or shapes with openings or apertures.

Method for Making Variably-Tensed Composite Cushioning Materials

In another aspect, the invention is drawn to a method of making composite cushioning materials incorporating, among other things and without limitations, one or two sheeting structures or substrate layers. Single laminate composite materials may optionally be made by a process comprising: (1) Applying a suitable adhesive to one or two opposing surfaces of a sheet of resilient material; (2) cutting the sheet of resilient material, to define and make a plurality of discrete resilient elements; (3) bonding a plurality of discrete resilient elements onto at least one sheeting structure or substrate layer; (4) mechanically stretching the substrate layer to which the resilient elements are bound, and increasing the relative distance between the discrete resilient elements, thereby creating spacing between them; (4) positioning one or more framing elements, which may optionally include holes shaped and sized to engage one or more resilient elements, in proximity with the resilient elements; (5) inserting one or more framing elements between at least two resilient elements, or optionally engaging one or more resilient elements to one or more holes in a framing element; and (6) optionally bonding a framing element to a substrate layer, thereby making a single laminate composite. It is understood that (7) a second substrate layer may optionally be bonded to the resilient elements in the single laminate composite, so that the resilient elements and one or more framing elements are “sandwiched” between the two sheets of substrate layer, thereby making a dual laminate composite.

Assembly of Single Laminate Variably-Tensed Cushioning Composites

As an initial step in the process, a sheet of resilient material is optionally coated with adhesive on two opposing sides. Alternatively, the sheet of resilient material may optionally be coated with adhesive on a single side.

In one aspect of the invention, the composition of resilient material may include, without limitations, a foam, including EVA foam, olefin or polyolefin foam, PU foam, urethane based foam, other polymer or thermoplastic foam, or rubber, elastomer, or other material with suitable shock absorbing characteristics, or resistant to puncture or abrasion (including a combination of any such materials). In one embodiment of the invention, the sheet of resilient material is optionally made of EVA foam.

The adhesive applied to one or two sides of the sheet of resilient material may optionally be comprised of an HMA film that is activated by heat, or heat and pressure. Depending on the type of material and the composition of the resilient elements and the substrate layers, the adhesive may optionally include EVA, olefin, or polyolefin-based adhesive, glue, or HMA film; PU or urethane based adhesive, glue, or HMA film; or polyamine based adhesive, glue, or HMA film.

In one embodiment of the invention, the adhesive used for this purpose is optionally an EVA or olefin based HMA film, activated by heat. However, it is understood that the adhesive may optionally comprise any glue, bonding agent or compound, adhesive film or laminate, solvent, or tape that permits the resilient material to bond or adhere to a substrate layer, such as first substrate layer 351 or second substrate layer 352. It is also understood that for purposes of this embodiment of the invention, any compound, substance, attachment, or device (including tape, Velcro® or other interlocking mechanical means) suitable for bonding the resilient material to the substrate layers may be used as an adhesive.

Depending on the composition of the first substrate layer 351 and second substrate layer 352, and the composition of the resilient material, the same or different types of adhesives, or combination of adhesives, may optionally be applied to the opposing sides of the sheet of resilient material.

It is understood that any conventional method for positioning, applying, or coating a HMA film to a suitable resilient element may be used for this purpose, as any HMA film having any particular melting temperature may be used to apply or coat the film to the resilient elements, so as to create adhered material.

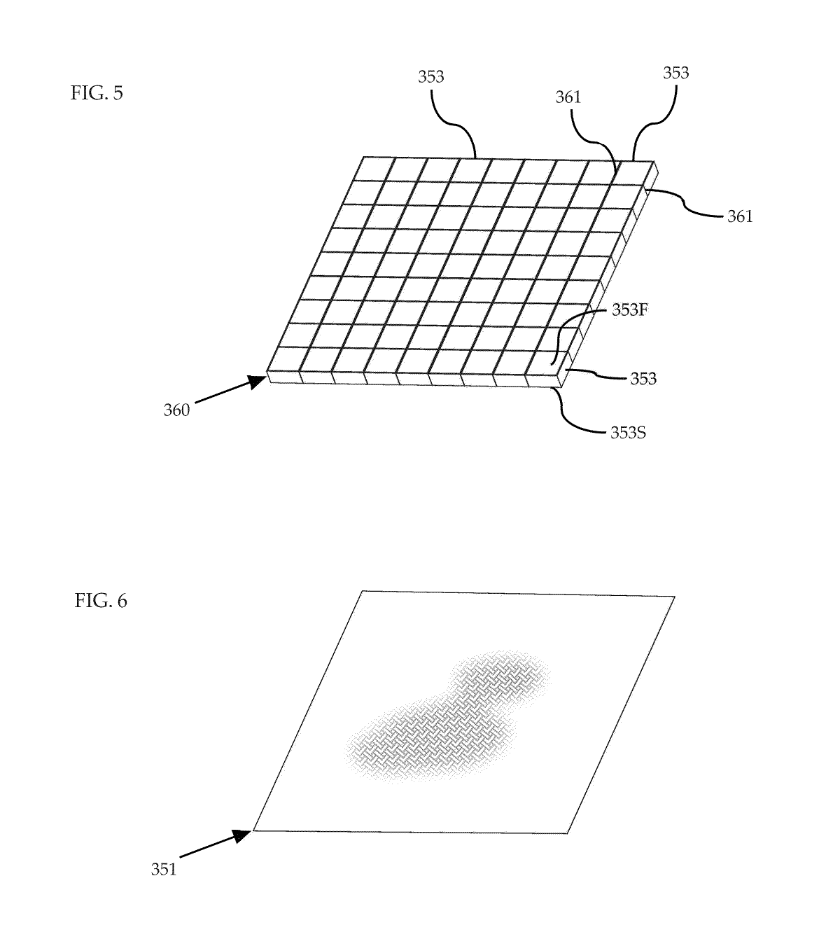

FIG. 5 depicts the sheet of resilient material, which is optionally coated with adhesive on one or two sides, cut along a plurality of cutting lines 361, forming a cut sheet of resilient material 360. Cutting lines 361 define and create a plurality of discrete resilient elements, such as, by way of example only, resilient elements 353.

It is understood that any conventional method for cutting resilient materials may be used to cut the sheet of resilient material and to make the cut sheet of resilient material 360. Optionally, any of the methods for cutting resilient materials disclosed in U.S. patent application Ser. No. 12/624,881 may be used for this purpose. The contents of U.S. patent application Ser. No. 12/624,881, filed Nov. 24, 2009 is incorporated by reference herein in its entirety, and in particular for its disclosure of various methods of cutting resilient material.

It is understood that the sheet of resilient material may be covered or coated with an adhesive on one or optionally two of its sides prior to the cutting operation. Therefore, following the cutting operation, the surface of first side 353F of the resilient elements (such as, by way of example and without limitations, resilient elements 353) is covered or coated with an adhesive and that, optionally, the surface of second side 353S of the same resilient elements may also be covered or coated with an adhesive.

However, in an optional and alternative embodiment of the invention, the sheet of resilient material may be cut along cutting lines 361 first, defining and forming a plurality of discrete resilient elements 353, and then the adhesive may be applied to first side 353F of the cut resilient elements 353, second side 353F of the cut resilient elements 353, or optionally to both sides of the cut resilient elements.

Cutting lines 361 shown in FIG. 5 are shaped like straight lines, and the resulting resilient elements 353 are shaped like square cuboids, as depicted in FIG. 5. However, cutting lines 361 may optionally be made in a variety of suitable shapes and dimensions, to define and create discrete resilient elements with a variety of optional shapes and dimensions, such as cubes, cylinders (including, without limitations, circular and elliptic cylinders), cuboids (including, without limitations, rectangular cuboids), hexagonal prisms, triangular prisms, tapered pyramids, and so forth. By way of example only, and without limitations, FIG. 22 depicts second single laminate composite 371, wherein the resilient elements (namely, resilient elements 353B) are optionally shaped like elliptic cylinders; FIG. 38B depicts resilient elements (namely, resilient elements 353C) that are optionally shaped like round cylinders; and FIGS. 17A-18B and 20B depict resilient elements (namely, resilient elements 353D) that are optionally shaped like cubes.

In the cut sheet of resilient material 360 depicted in FIG. 5, cutting lines 361 are shown as cutting the sheet of resilient material in its entirety, from edge to edge, and defining and forming a plurality of discrete resilient elements 353.

FIG. 6 depicts a sheeting structure or substrate layer, such as, by way of example only, first substrate layer 351. In one embodiment of the invention, first substrate layer 351 is optionally comprised of a sheet or layer of synthetic, non-woven stretchable fabric such as spandex, or stretchable nylon or polyester mesh. However, it is understood first substrate layer 351 may optionally be comprised of a sheet or layer of any material that is relatively flexible and stretchable and may be used as a sheeting structure, including, without limitations, natural or synthetic fabric (including, by way of example only and without limitations, polyester, nylon, Lycra®, or elastane), stretchable mesh (including open mesh), flexible or pliable plastic, neoprene, natural leather, synthetic leather, or a sheet of synthetic fiber, or a combination of such materials. Optionally, the substrate layer may also be made of any flexible and stretchable sheet of foam, plastic, latex, silicone, rubber, other rubber-like materials, elastomer, and so forth, including any combination of such materials. Optionally, the substrate layer may also be comprised of any such materials encased in, laminated with, or sandwiched between sheets of natural or synthetic fabric, or other materials.

It is understood that a suitable composition for the substrate layers may optionally be selected from a wide variety and range of materials that are flexible and stretchable, provided that the resulting substrate layer may be made to bond to resilient elements (such as, by way of example only, resilient elements 353, 353A, 353B, 353C, and 353D).

In an alternative embodiment of the invention, adhesive may optionally be applied to a substrate layer (such as, by way of example, first substrate layer 351, or second substrate layer 352), instead of the sides of the resilient elements (such as, by way of example, first side 353F or second side 353S of resilient elements 353), in order to bond the resilient elements to the substrate layer.

FIG. 6 depicts first substrate layer 351 as roughly rectangular in shape; however, it is understood that such shape is optional, and that first substrate layer 351 may be comprised of materials cut or shaped in any shape, size, dimension, or thickness, including irregular shapes and shapes that include apertures. In another aspect of the invention, first substrate layer 351 may optionally be shaped so as to cover only some of the plurality of resilient elements, optionally leaving one or more resilient elements exposed. Also optionally, first substrate layer 351 may include apertures or holes that partially expose one or more resilient elements.

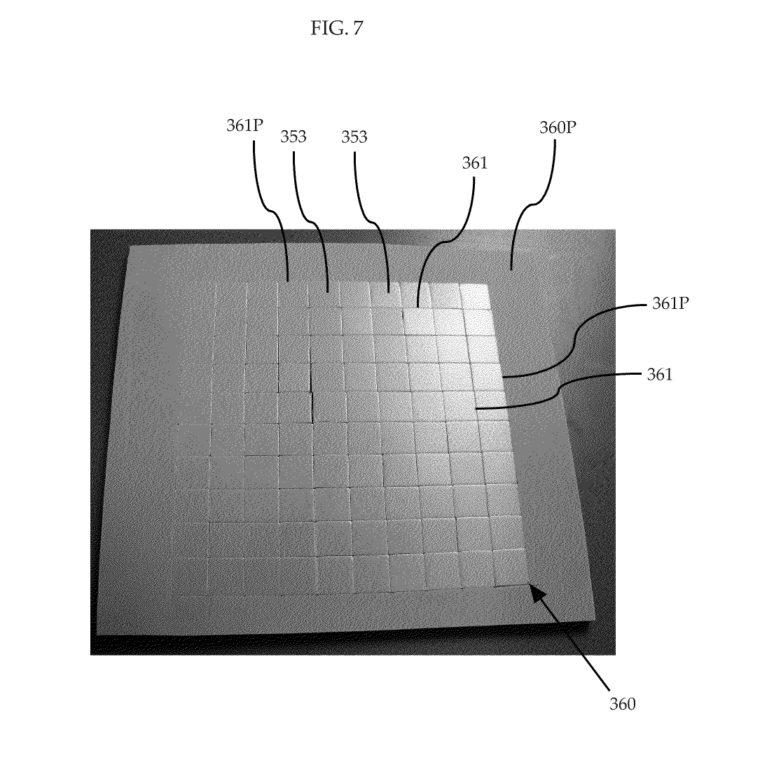

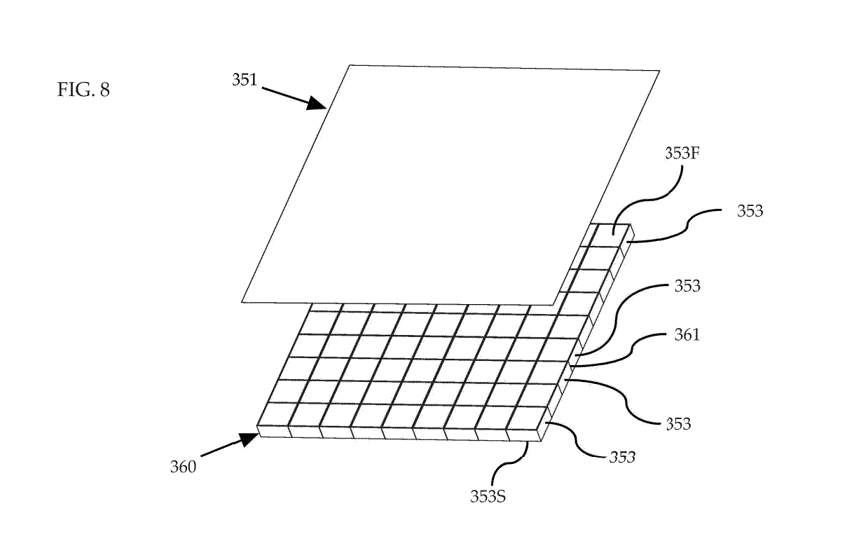

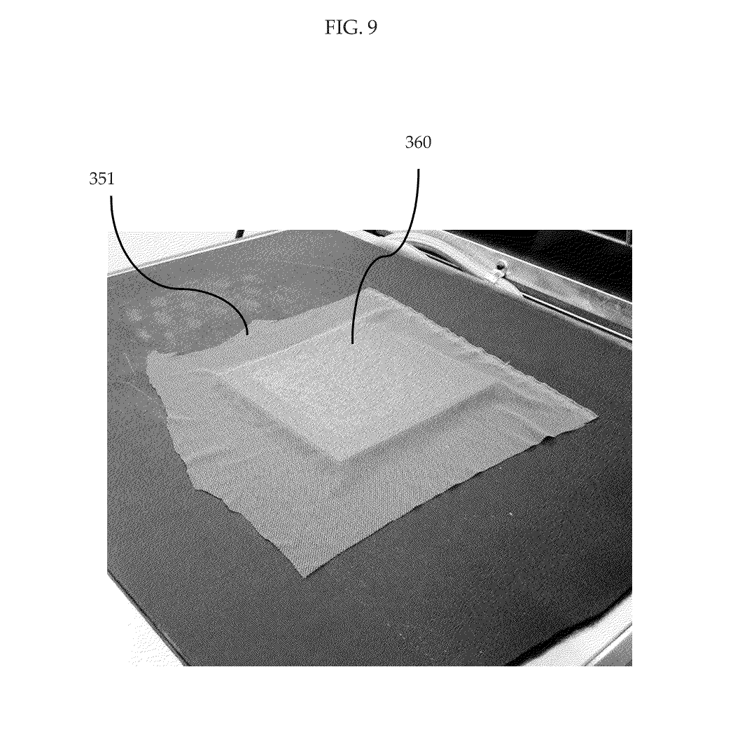

FIG. 7 depicts an optional and alternative embodiment of the invention, wherein the sheet of resilient material is cut to form a peripheral edge of resilient material that surrounds the plurality of resilient elements. As shown in FIG. 7, the sheet of resilient material may optionally be cut along a perimetral edge cutting line 361P, to define and create a contiguous perimetral edge material 360P that surrounds the outer edge of the plurality of discrete resilient elements 353. It is understood that perimetral edge material 360P may optionally aid in keeping the plurality of discrete resilient elements 353 in place and arranged in an array, while the cut sheet of resilient material is moved or positioned next to first substrate layer 351, as depicted in FIGS. 8-9, for lamination or bonding. It is further understood that the perimetral edge material 360P depicted in FIG. 7 may optionally be extracted and removed from the assembly, leaving behind the cut sheet of resilient material 360 that is laminated to first substrate layer 351.

FIGS. 8 through 11B depict the lamination of the first substrate layer 351 onto a plurality of resilient elements (such as, by way of example only, resilient elements 353) comprising the cut sheet of resilient material (such as, by way of example only, cut sheet of resilient material 360), to form a laminated resilient material assembly (such as, by way of example only, laminated resilient material assembly 362A).

FIGS. 8 and 9 depict first substrate layer 351 optionally positioned above the cut sheet of resilient material 360 and making contact with the same. It is understood, however, that the first substrate layer 351 may optionally be positioned beneath the cut sheet of resilient material 360.

The assembly, comprised of first substrate layer 351 positioned adjacent to a plurality of resilient elements 353 in the cut sheet of resilient material 360, is pressed together, so that the resilient elements 353 bond or are made to adhere to first substrate layer 351. If the adhesive on the surface of the resilient elements 353 is a heat activated HMA film, glue, or other bonding agent, the assembly may be heat pressed in order to activate the adhesive.

Any means or device for pressing or optionally heat-pressing first substrate layer 351 and the plurality of resilient elements 353 together, such as a pressure press or a heated press or platen, may be employed for this purpose.

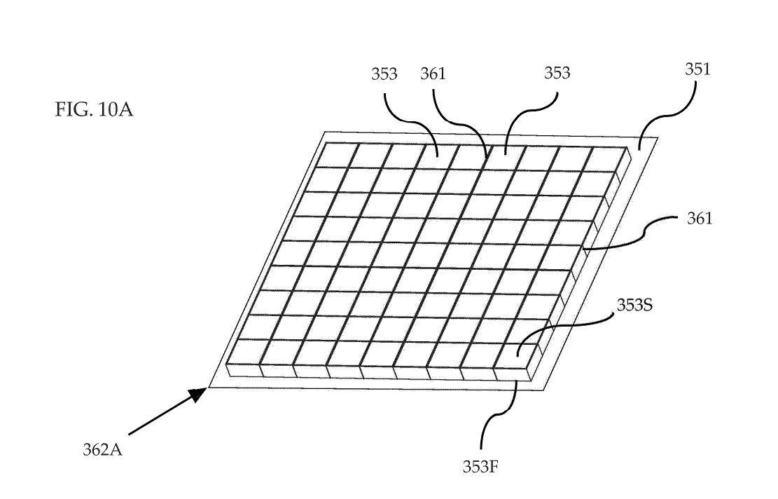

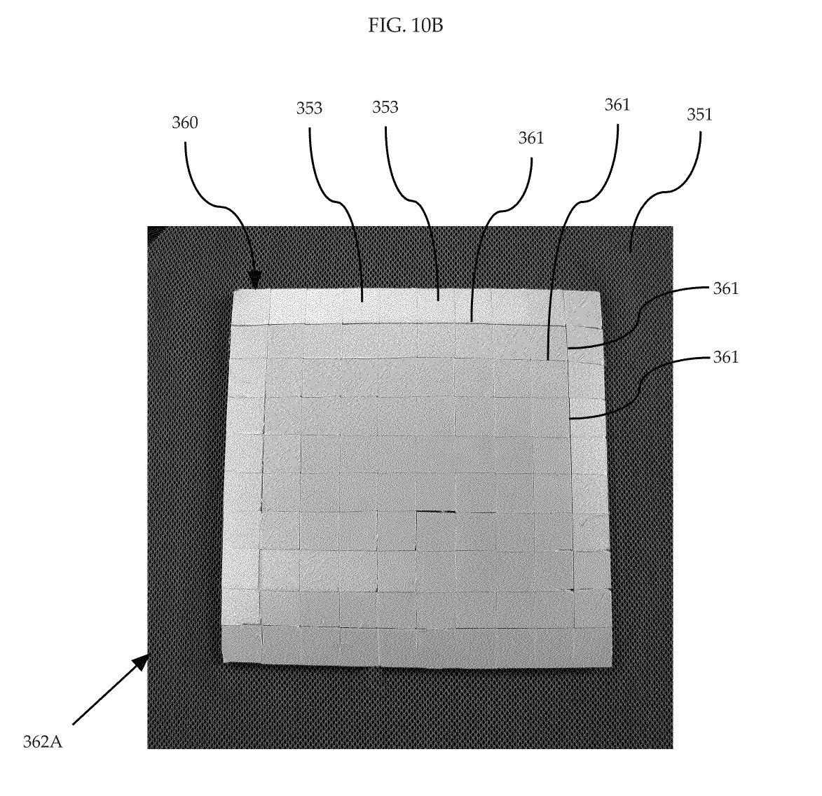

FIGS. 10A and 10B depict a laminated resilient material assembly 362A formed by the pressing or heat-pressing operation, comprising a plurality of discrete resilient elements 353 separate from each other by cutting lines 361, and bonded to first substrate layer 351.

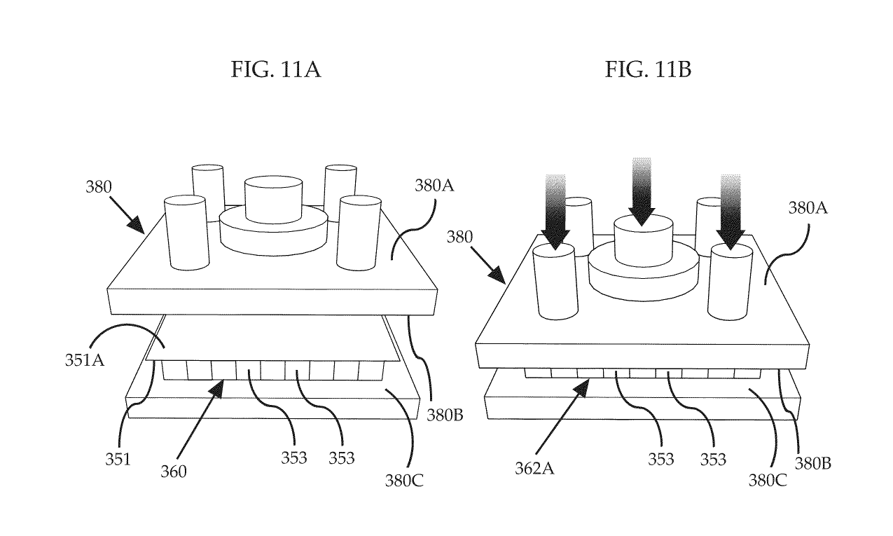

FIGS. 11A and 11B depict a non-limiting example of heat-pressing operation that may be optionally utilized to laminate a substrate layer to resilient elements. As depicted in FIG. 11A, cut sheet of resilient material 360 is optionally placed flat adjacent to a work surface 380C, and first substrate layer 351 is positioned flat on the opposite side of cut sheet of resilient material 360. Pressure platen 380, which includes a pressing element 380A and an optional heating element 380B, is positioned adjacent to substrate side 351A of first substrate layer 351, so that the work piece comprised of first substrate layer 351 and cut sheet of resilient material 360 is positioned between pressure platen 380 and work surface 380C, and first substrate layer 351 faces heating element 380B, and the array of resilient elements 353 face work surface 380C.

Optionally, the surface of heating element 380B, the lower surface of the pressure platen 380, or the work surface 380C may incorporate or be coated with one or more non-reactive materials (such as silicone, polytetrafluoroethylene/PTFE, perfluoroalkoxy/PFA, fluorinated ethylene propylene/FEP, Teflon, or other similar non-reactive material) that do not adhere to exposed adhesive, if any, on the surface of the resilient elements that are not fully covered by first substrate layer 351 (It is understood that this may be the case if, by way of example only, first substrate layer 351 is optionally shaped so as to cover only some of the plurality of resilient elements).

FIG. 11B depicts pressure platen 380 in an engaged state, pressing against work surface 380C, with the work piece comprised of first substrate layer 351 and cut sheet of resilient material 360 “sandwiched” between the pressing element 380A or the optional heating element 380B, on the one hand, and work surface 380C, on the other hand, and pressed or optionally heat-pressed in the process. This results in laminated resilient material assembly 362A, as depicted in FIG. 11B.

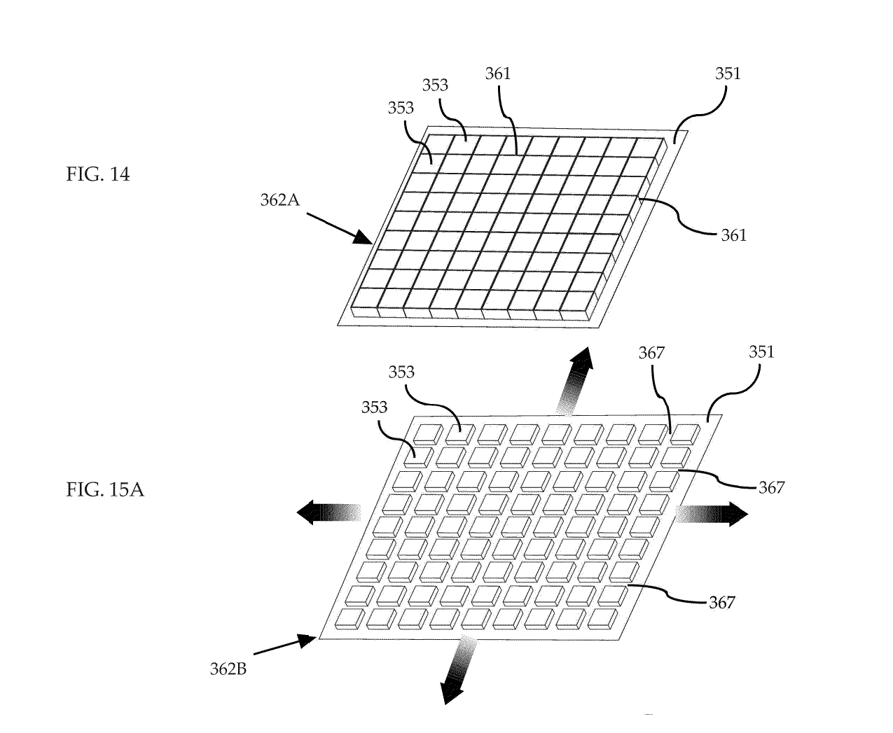

FIG. 14 depicts laminated resilient material assembly 362A following the pressing or heat-pressing operation. Laminated resilient material assembly 362A comprises a plurality of discrete resilient elements 353 bonded to first substrate layer 351. In one embodiment of the invention, resilient elements 353 are separated from each other along cutting lines 361, and there is no appreciable spacing between the discrete resilient elements 353; additionally, first substrate layer 351 is in a non-stretched, or “relaxed,” state.

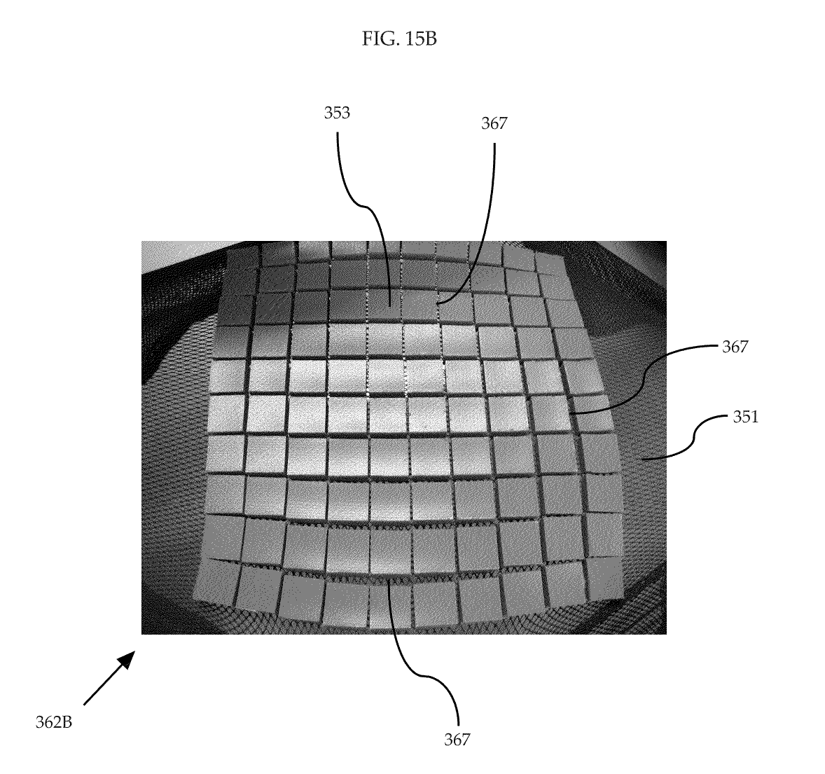

FIG. 15A depicts first stretched resilient material assembly 362B, comprising of laminated resilient material assembly 362A in a stretched out, or “tensed,” state. The first stretched resilient material assembly 362B may be formed by optionally stretching the laminated resilient material assembly 362A, or the first substrate layer 351 in the said laminated resilient material assembly, along one or more axis indicated by the dotted arrows.

As depicted in FIG. 15A, as first substrate layer 351 is stretched out, spacing 367 is created between the discrete resilient elements (such as, by way of example only, resilient elements 353) that are bonded to the substrate layer (such as, by way of example only, first substrate layer 351).

FIG. 15B depicts another view of the first stretched resilient material assembly 362B, with the first substrate layer 351 in a stretched out, or “tensed,” state, and the spacing 367 between a plurality discrete resilient elements 353 that are bonded to the substrate layer.

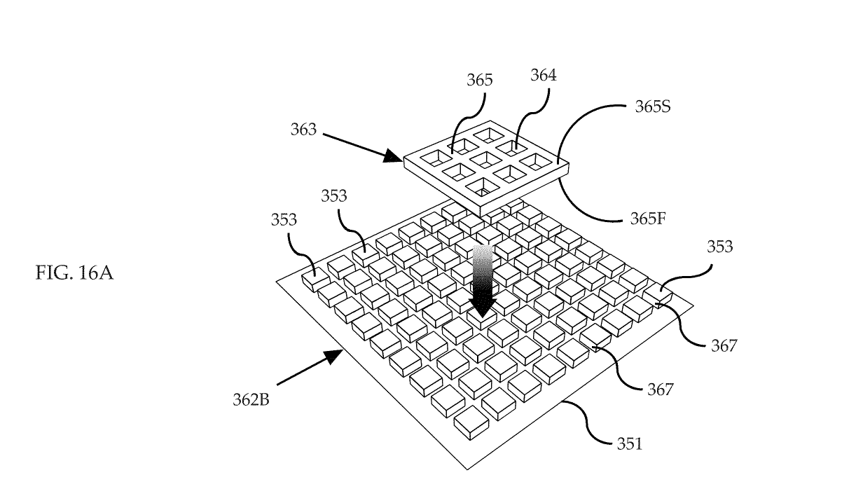

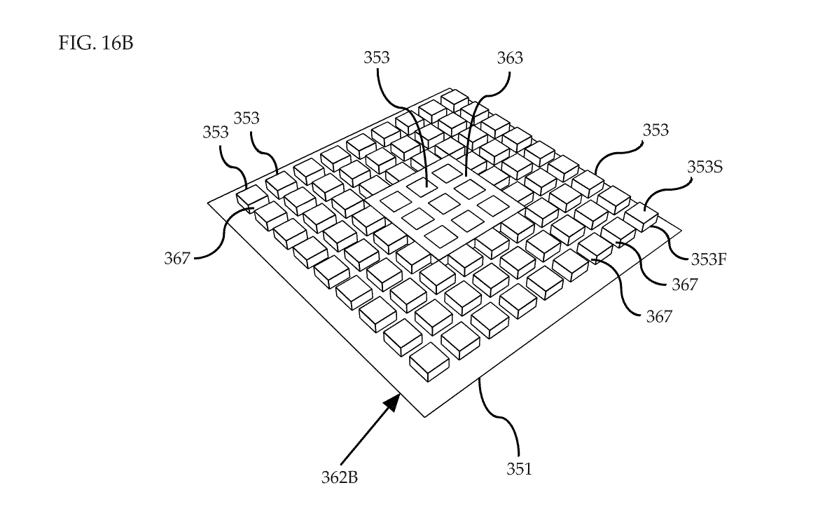

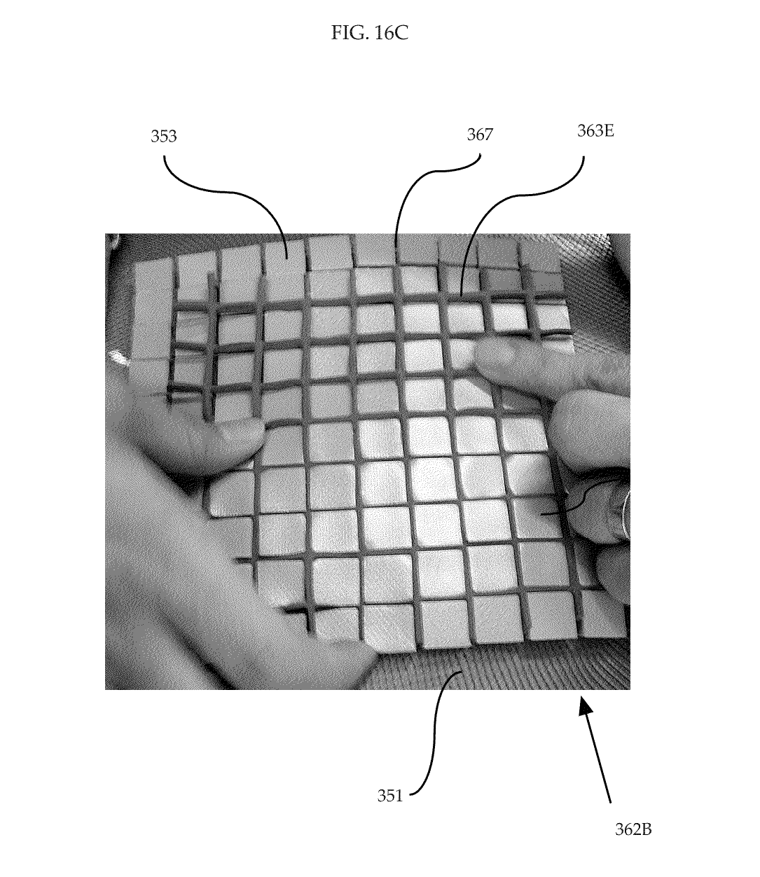

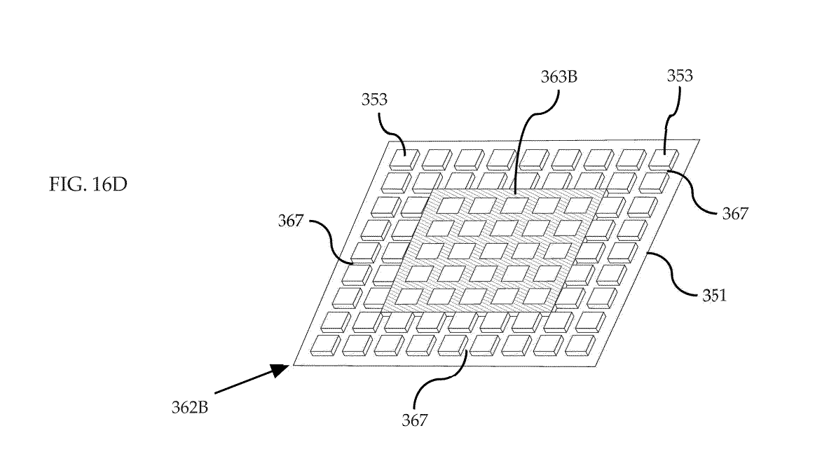

As depicted in FIGS. 16A and 16B, while the substrate layer in the stretched resilient material assembly 362B is in a stretched out state, and the resilient elements bonded to the substrate layer have spaced apart in relation to each other, one or more framing elements are inserted into the spacing 367 between the resilient elements, and optionally made to engage one or more resilient elements.

By way of example only, FIG. 16A depicts framing element 363, comprising a lattice of resilient material 365 with a plurality of holes 364, being positioned adjacent to resilient elements 353 in the first stretched resilient material assembly 362B. It is understood that the resilient elements are bonded to first substrate layer 351, and that first substrate layer 351 is stretched out, thereby causing resilient elements 353 to move apart in relation to each other, creating spacing 367 between them as shown in FIG. 16A.

FIG. 16B depicts framing element 363 inserted into spacing 367 between the resilient elements 353, and engaging a plurality of resilient elements 353. In this embodiment of the invention, holes 364 in the framing element 363 are optionally shaped and dimensioned so as to accept a plurality of resilient elements 353, as depicted in FIG. 16B.

In one embodiment of the invention, the framing element (such as framing element 363) is not bonded to a substrate layer (such as first substrate layer 351). However, it is understood that alternatively, and optionally, a suitable adhesive may be applied to first side 365F of the framing element (such as framing element 363, depicted in FIG. 16A), and the framing element may optionally be bonded to a substrate layer (such as first substrate layer 351) while the said substrate layer is in a stretched state. Optionally, a suitable adhesive may also be applied to second side 365S of the framing element (such as framing element 363, depicted in FIG. 16A), to enable the framing element to bond to a second substrate layer (such as second substrate layer 352).

FIG. 16C shows another non-limiting example of a framing element inserted into the spacing between the resilient elements that are bonded to a stretched out substrate layer, wherein the framing element engages some of the resilient elements. FIG. 16C depicts framing element 363E being inserted and fitted into spacing 367 between the resilient elements 353 in the first stretched resilient material assembly 362B, while first substrate layer 351 is in a stretched, or “tensed,” state. It is understood that framing element 363E comprises a lattice of resilient material 365 with holes 364, as depicted in greater detail in FIGS. 12F and 13, and that holes 364 are shaped and sized so as to accept a plurality of resilient elements 353.

It is understood that the resilient elements may optionally have a variety of thicknesses, shapes, and dimensions, as shown, by way of example only and without limitations, in FIG. 1A (depicting resilient elements 353A, shaped like triangular prisms), FIGS. 16A-16C (depicting resilient elements 353, shaped like square cuboids), FIG. 22 (depicting resilient element 353B, shaped like elliptic cylinders), and FIG. 38B (depicting resilient elements 353C, shaped like cylinders).

It is also understood that framing elements may also have a variety of optional shapes, dimensions, and thicknesses, as shown by way of example only and without limitations in FIGS. 12A-12T and FIG. 13. Furthermore, framing elements may optionally have the same thickness or height as the resilient elements; alternatively, and optionally, framing elements may be thinner or have lower height than the resilient elements. In another aspect of the invention, framing elements may optionally be thicker or have greater height than the resilient elements.

FIG. 16D depicts a non-limiting example of a framing element (namely, framing element 363B) that optionally has a larger perimeter area than framing element 363, and is inserted into the spacing between a plurality of resilient elements that are bonded to a substrate layer, with the framing element engaging some of the resilient elements. Framing element 363B is also depicted by itself in FIG. 12C. In FIG. 16D, framing element 363B is shown fitted and inserted into the spacing 367 between the resilient elements 353, while the first substrate layer 351 is in a stretched, or “tensed,” state. As shown in FIG. 16D, framing element 363B optionally engages a larger number of discrete resilient elements 353 in the first stretched resilient material assembly 362B than framing element 363.

FIGS. 17A and 17B depict a non-limiting example of a framing element (namely, framing element 363) that is optionally thinner, or “shorter,” than the resilient elements (namely, resilient elements 353D, which are optionally cube-shaped), wherein the framing element is inserted into the spacing between a plurality of resilient elements bonded to a substrate layer (namely, first resilient element 351). Framing element 363 is also depicted by itself in FIG. 12A. As shown in FIG. 17A, framing element 363 is fitted into spacing 367 between the resilient elements 353D.

In one aspect of the invention, framing element 363 depicted in FIG. 12A may be positioned against the second stretched resilient material assembly 362C, and holes 364 in the framing element may be aligned with and made to engage a plurality of resilient elements 353D in the second stretched resilient material assembly 362C. Framing element 363A may optionally be pressed against second stretched resilient material assembly 362C and towards first substrate layer 351, to a point in which second side 365S of the framing element 363A does not make contact with the first substrate layer 351, as depicted in FIG. 17B.

Alternatively, and optionally, framing element 363 may be pressed against second stretched resilient material assembly 362C so that holes 364 engage the resilient elements 353D, and pushed until second side 365S of the framing element 363A makes contact with the first substrate layer 351. Also optionally, second side 365S of the framing element 363 may be covered with an adhesive, and second side 365S of the framing element may optionally be made to bond and adhere to first substrate layer 351.

FIGS. 18A and 18B depict another non-limiting example of a framing element (in this case, framing element 363A) engaging resilient elements (namely, resilient elements 353D) that are optionally cube-shaped. It is understood that framing element 363A is also depicted by itself in FIG. 12B. In FIG. 18A, framing element 363A is shown fitted and inserted into spacing 367 between the resilient elements 353D in the second stretched resilient material assembly 362C.

In one aspect of the invention, framing element 363A depicted in FIG. 12B and in FIGS. 18A-18B may be positioned against the second stretched resilient material assembly 362C, and holes 364 in the framing element may be aligned with and made to engage a plurality of resilient elements 353D in the stretched resilient material assembly. It is understood that in this optional embodiment of the invention, framing element 363A has the same thickness, or “height,” as the resilient elements 353D. Optionally, framing element 363A may be pressed against second stretched resilient material assembly 362C so that holes 364 engage the resilient elements 353D, and pushed until second side 365S of the framing element 363A makes contact with first substrate layer 351. Also optionally, second side 365S of the framing element 363A may be covered with an adhesive, and second side 365S of the framing element may optionally be made to bond and adhere to first substrate layer 351.

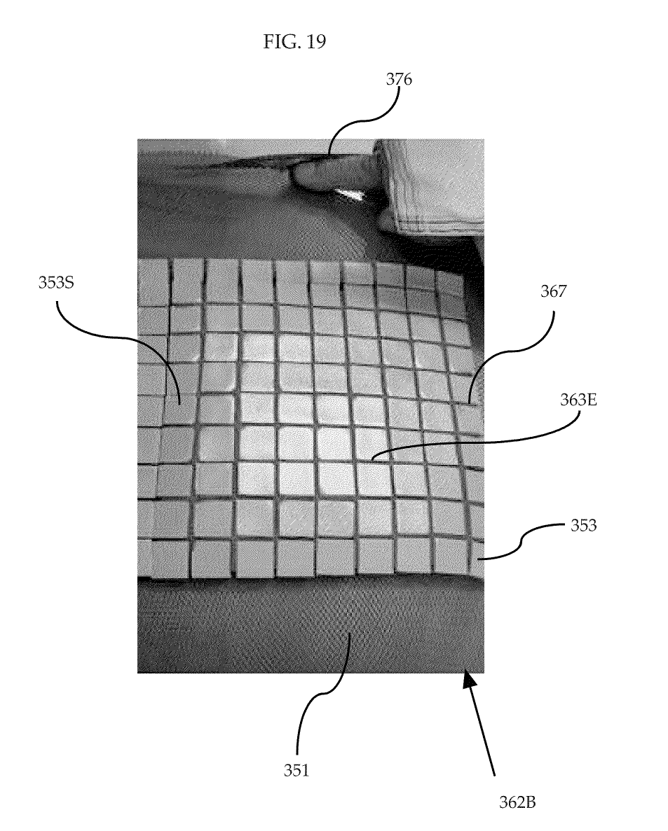

FIG. 19 depicts yet another non-limiting example of a framing element (in this case, framing element 363E) engaging resilient elements (namely, resilient elements 353). It is understood that framing element 363E is also depicted by itself in FIGS. 12F and 13. In FIG. 19, framing element 363 is shown fitted and inserted into spacing 367 between the resilient elements 353, wherein the resilient elements are bonded to the first substrate layer 351 in the first stretched resilient material assembly 362B. It is understood that FIG. 19 depicts the first substrate layer 351 in a stretched out, or “tensed,” state.

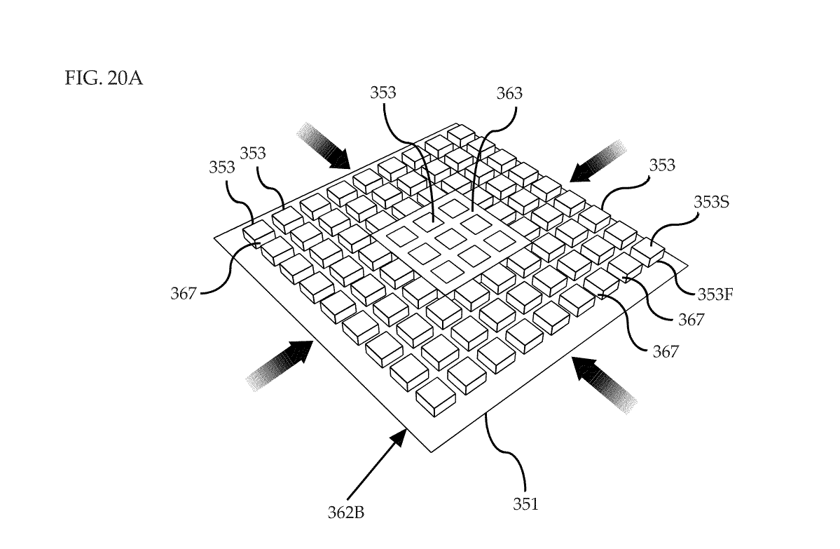

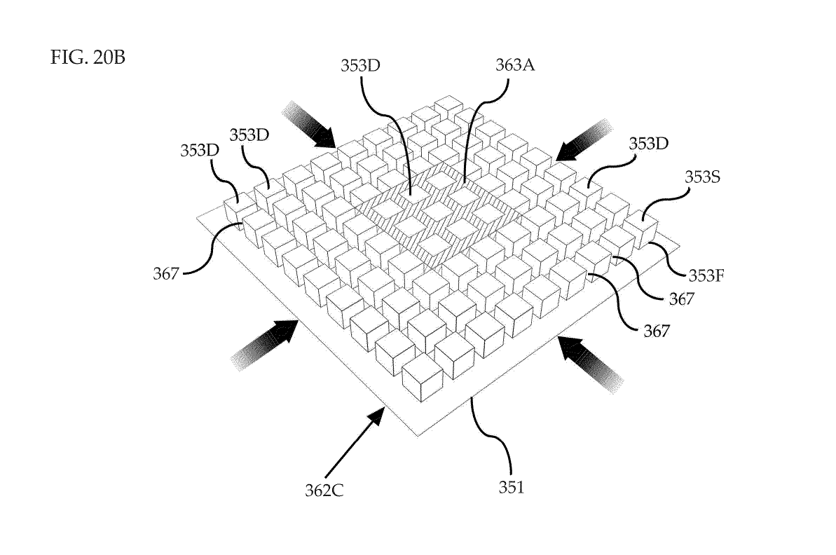

As depicted in FIG. 20A, after one or more framing elements (such as, by way of example, framing element 363) have been inserted and fitted into the spacing 367 between a plurality of discrete resilient elements (such as, by way of example only, resilient elements 353) in a stretched resilient material assembly (such as, by way of example only, first stretched resilient material assembly 362B), and may have optionally been bonded to the substrate layer therein (such as, by way of example, first substrate layer 351), the substrate layer is returned to a non-stretched state, as indicated by the dotted arrows. It is understood that as the substrate layer returns to a non-stretched size, the discrete resilient elements bonded to the substrate layer come back together, and the spacing 367 between the resilient elements decreases.

Another non-limiting example of this step is depicted in FIG. 20B. In FIG. 20B, after framing element 363A has been inserted and fitted into the spacing 367 between a plurality of discrete resilient elements 353D in the second stretched resilient material assembly 362C, and may have optionally been bonded to first substrate layer 351, the substrate layer is returned to a non-stretched state, as indicated by the dotted arrows. As first substrate layer 351 returns to a non-stretched size, the discrete resilient elements bonded to the substrate layer come back together, and the spacing 367 between the resilient elements decreases.

However, it is understood that the framing element or its parts, optionally positioned between two or more resilient elements, or optionally engaged to one or more resilient elements, prevent the portions or zones of the substrate layer located adjacent to the framing element from returning to a non-stretched state, even as the substrate layer as a whole returns to a non-stretched state. It is also understood that the said framing element may also prevent two or more of the resilient elements bounded or engaged by the framing element from coming back together in relation to each other, even as the substrate layer as a whole returns to a non-stretched state and the other resilient elements bonded to the substrate layer come back together, thereby reducing or eliminating the spacing between such other resilient elements.

It is further understood that in the regions or zones of the substrate layer on which a framing element bounds or engages one or more resilient elements, the substrate layer material may be prevented from returning, or shrinking, back to its “relaxed” dimensions. In those zones, the substrate layer material remains in a relatively more stretched, or “tensed,” state than in the rest of the substrate layer.

By way of example only, and without limitations, FIG. 21 depicts first stretched resilient material assembly 362B after first substrate layer 351 has been returned to a non-stretched, or “relaxed,” state. As depicted in FIG. 21, those resilient elements 353 that are engaged to framing element 363 do not move in relation to each other, and those resilient elements 353 that are bounded by the framing element 363 or parts thereof do not move in relation to the other resilient elements that are also bounded by the said framing element. In contrast, those resilient elements 353 that are not bounded by or engaged to a framing element move closer to the neighboring resilient elements, as the first substrate layer 351 (to which the resilient elements are bound) return to a non-stretched state.

As shown in FIG. 21, as the first substrate layer 351 (to which the resilient elements are bound) returns to a non-stretched state, the resilient elements in the first stretched resilient material assembly 362B move closer to its neighboring resilient elements, and spacing 367 between the resilient elements may decrease or optionally disappear. However, it is understood that in the region of the work piece defined by the framing element 363 (namely, variably-tensed zone 350C, depicted in FIG. 21), one or more resilient elements 353 are bounded and prevented from moving closer to its neighboring resilient elements by the framing element 363. It is also understood that in the portion of the first substrate layer 351 located within the variably-tensed zone 350C, and between the resilient elements 353, the substrate layer material is prevented from returning to a non-stretched, or “relaxed,” state.

Optionally, the entire work piece depicted in FIG. 21 may take on a curved shape, forming a single laminate composite, namely, first single laminate composite 370A. It is understood that first single laminate composite 370A may have a convex shape on its first side 350A, and a concave shape on its second side 350B, as depicted in FIG. 21. It is also understood that by optionally varying the size, shape, and composition of the framing elements and the substrate layers, and the size, shape, and placement of the resilient elements, the resulting single laminate composite may optionally take on a greater or lesser degree of concavity or convexity, or take on a “half-pipe” shape shown in FIG. 24.

In one aspect of the invention, framing element 363 may be optionally bonded to substrate layer 351 in the first single laminate composite 370A after substrate layer 351 has been returned to a non-stretched state. This may be accomplished by treating or covering second side 365S of the framing element 363 with an adhesive, contacting the second side 365S of the framing element to the first substrate layer 351, and optionally pressing or heat pressing the work piece with the first substrate layer 351 in a non-stretched or “relaxed” state. It is understood that the pressing or heat pressing operations may optionally be carried out using the pressure platen 380 depicted in FIGS. 11A and 11B.

It is understood that the process generally described above may be used to make a variety of single laminate composite materials, including, by way of example only and without limitations, second single laminate composite 371 depicted in FIG. 22 (comprising, among other things, a plurality of discrete resilient elements 353B bounded by or engaged to the framing element 363Q), and fourth single laminate composite 372 depicted in FIG. 24 (comprising, among other things, a plurality of discrete resilient elements 353 bounded by or engaged to the framing element 363E).

In another aspect of the invention, the first single laminate composite 370A depicted in FIG. 21 may be processed further to optionally make third single laminate composite 370B, depicted in FIG. 23. In this aspect of the invention, pressure may be applied to the outer surface of first single laminate composite 370A, from the first side 350A of the single laminate composite towards its second side 350B, reversing the concavity-convexity of the work piece, and forming third single laminate composite 370B in a simple additional step. As shown in FIG. 23, third single laminate composite 370B may have a concave shape on its first side 350A, and a convex shape on its second side 350B.

Optionally, single laminate composite materials may be used as a protective padding, or as components in footwear or athletic or industrial protective gear. Alternatively, and optionally, single laminate composites may be processed further to make dual laminate composite materials.

Assembly of Dual Laminate Variably-Tensed Cushioning Composites

In one aspect of the invention, the process for assembling and making single laminate composite materials, described above and herein, may also be used to fabricate a variety of dual laminate composite materials.

In another aspect of the invention, a single laminate composite material may optionally be assembled and made in accordance with the steps described herein. A second substrate layer may be optionally laminated to the said single laminate composite, by bonding a second substrate layer to one or more resilient elements in the single laminate composite, forming a dual laminate composite material.

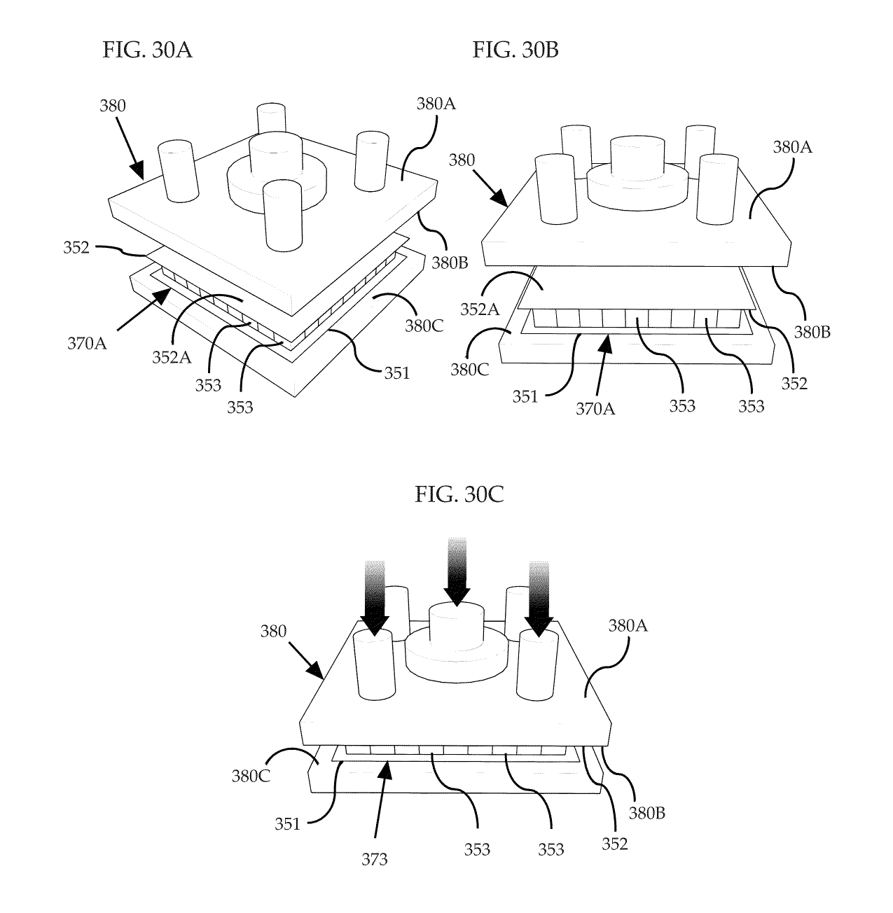

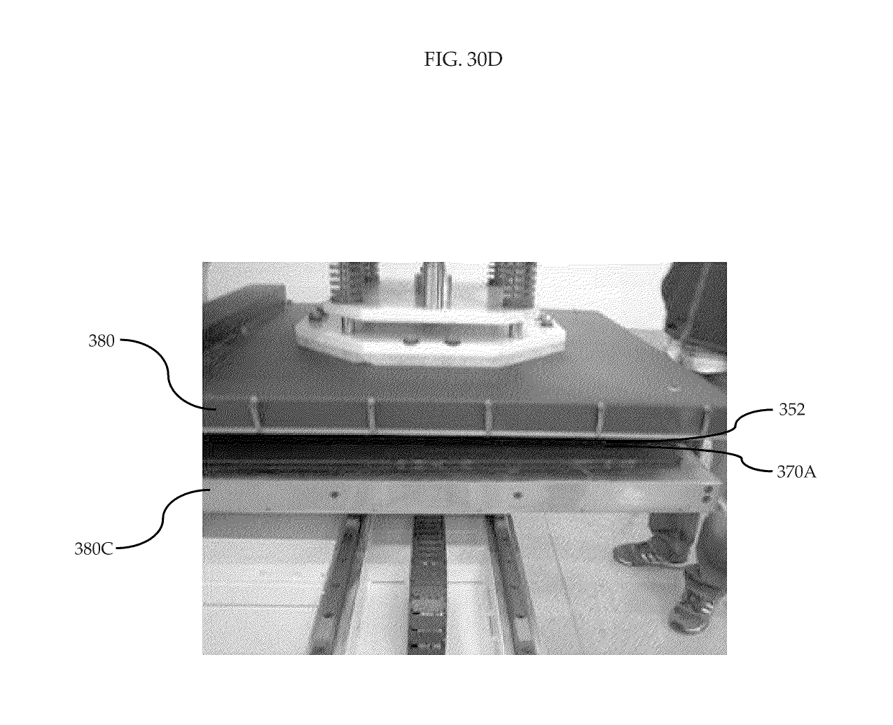

It is understood that any means for bonding a second substrate layer to the resilient elements in the single laminate composite may be utilized for this purpose, including, but not limited to, pressing or heat pressing operation carried out using the pressure platen 380 depicted in FIGS. 11A-11B, and in FIGS. 30A-30C.

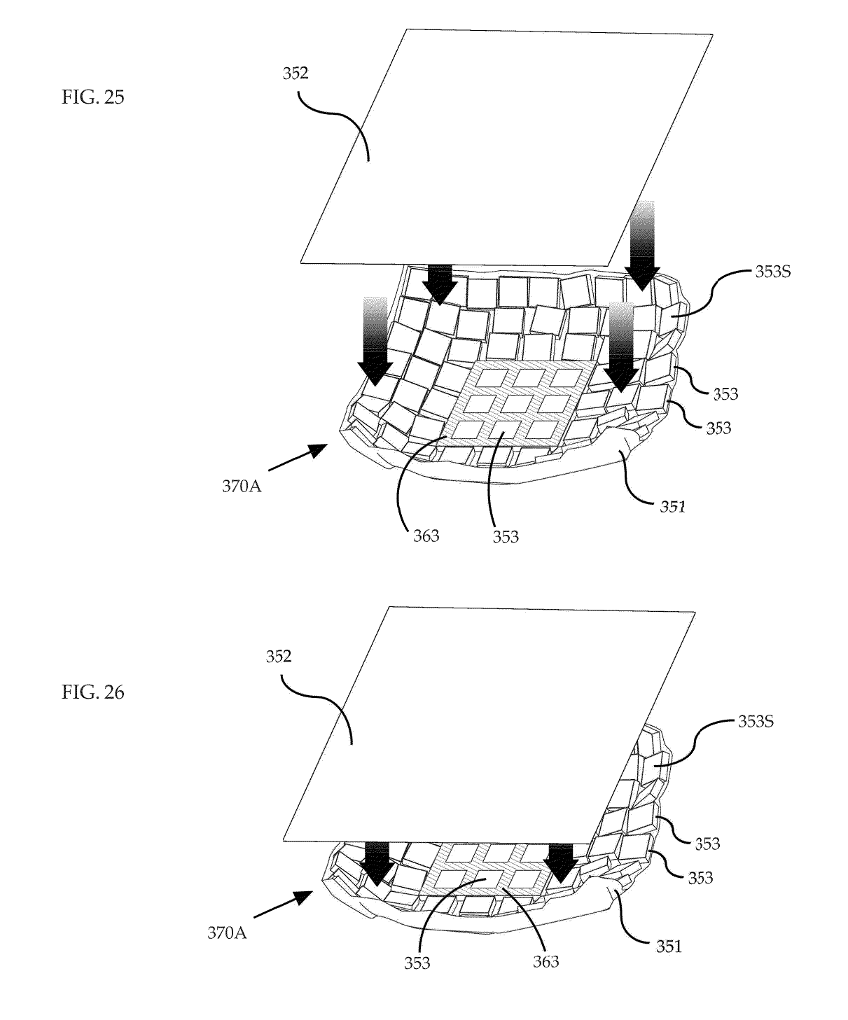

By way of example only, and without limitations, FIG. 25 depicts a single laminate composite material (in this case, first single laminate composite 370A), with the first substrate layer (namely, first substrate layer 351) in a non-stretched, or “relaxed,” state.

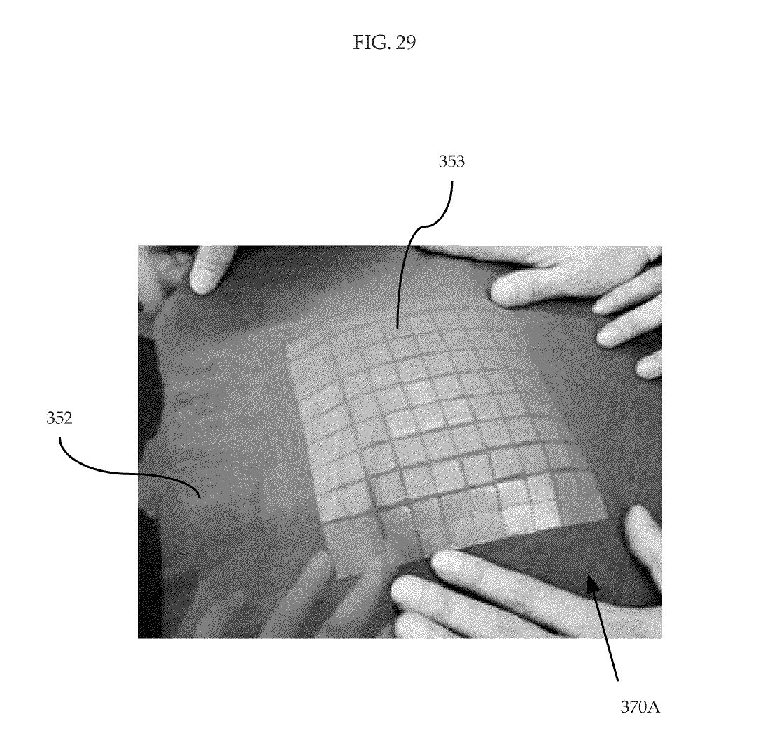

As shown in FIGS. 25 and 26, a second sheeting structure or substrate layer (in this case, second substrate layer 352) is optionally positioned adjacent to the first single laminate composite 370A, and second substrate layer 352 is made to contact a plurality of discrete resilient elements 353 in the first single laminate composite 370A, on the side of the said resilient elements not bonded to the first substrate layer 351. FIG. 29 depicts another non-limiting example of a second sheeting structure or substrate layer (such as second substrate layer 352) optionally positioned next to first single laminate composite 370A, in preparation for the lamination of the second substrate layer to the single laminate composite.

Second substrate layer 352 is bonded or made to adhere to one or more discrete resilient elements 353 in the first single laminate composite 370A. In one optional embodiment of the invention, adhesive may be applied to the surface of the resilient elements facing the second substrate layer 352, causing the resilient elements to bond to the substrate layer; in another optional embodiment of the invention, adhesive may be applied to the surface of the second substrate layer 352, causing the substrate layer to bond to the resilient elements.

Any means capable of bonding second substrate layer 352 to the resilient elements 353 in the first single laminate composite 370A may be utilized for this purpose. By way of example only, and without limitations, in one embodiment of the invention depicted in FIGS. 30A and 30B, second substrate layer 352 is optionally positioned over an instance of first single laminate composite 370A, so that the second substrate layer 352 contacts the exposed resilient elements 353. The stacked assembly or work piece (comprising the second substrate layer 352 laid out over the first single laminate composite 370A) may optionally be placed flat over a work surface 380C, as shown in FIGS. 30A and 30B.

Pressure platen 380, which includes a pressing element 380A and, optionally, a heating element 380B, may optionally be positioned over the work piece, so that the work piece is “sandwiched” between pressure platen 380 and work surface 380C, with the pressing element 380A, and optionally the heating element 380B, facing first side 352A of the second substrate layer 352.

It is understood that the surface of heating element 380B, the lower surface of the pressure platen 380, or the work surface 380C may optionally incorporate or be coated with one or more non-reactive materials (such as silicone, polytetrafluoroethylene/PTFE, perfluoroalkoxy/PFA, fluorinated ethylene propylene/FEP, Teflon, or other similar non-reactive material) that do not adhere to exposed adhesive, if any, on the surface of the resilient elements that are not fully covered by second substrate layer 352 (It is understood that this may be the case if, by way of example only, second substrate layer 352 is optionally shaped so as to cover only some of the plurality of resilient elements).

FIG. 30C depicts pressure platen 380 in an engaged state, pressing against work surface 380C, with the work piece comprised of second substrate layer 352 and first single laminate composite 370A “sandwiched” between the pressing element 380A (and the optional heating element 380B), on the one hand, and work surface 380C, on the other hand. The work piece is pressed or optionally heat-pressed, bonding the second substrate layer 352 to the resilient elements 353 in the first single laminate composite 370A as shown in FIG. 30C, forming first dual laminate composite 373.

FIG. 30D depicts another optional non-limiting example of pressure platen 380 positioned in relation to work surface 380C, with the work piece comprised of second substrate layer 352 and first single laminate composite 370A “sandwiched” between them.

FIGS. 25-26 depict a second substrate layer (in this case, second substrate layer 352) laminated or bonded to a single laminate composite material (in this case, first single laminate composite 370A), while the first substrate layer (namely, first substrate layer 351) is in a non-stretched, or “relaxed,” state.

However, it is understood that, optionally, the second substrate layer (such as second substrate layer 352) may be laminated or bonded to a single laminate composite material (such as first single laminate composite 370A), while the single laminate composite material and the first substrate layer therein (namely, first substrate layer 351) are stretched out, or in a “tensed” state. By way of illustration, FIG. 28 depicts second substrate layer 352 being positioned next to the first stretched resilient material assembly 362B, wherein first substrate layer 351 in the stretched resilient material assembly is in a stretched state. It is understood that second substrate layer 352 may be bonded, optionally through pressing or heat-pressing operation, to the resilient elements 353 in the first stretched resilient material assembly 362B, forming a single laminate composite material. In this optional and alternative embodiment of the invention, the first substrate layer 351 (and the single laminate composite material) are allowed to return to a non-stretched state after the second substrate layer 352 has been laminated to the second side 353S of the resilient elements in the first stretched resilient material assembly 362B.

In one embodiment of the invention, the second substrate layer (namely, second substrate laminate 352) is optionally comprised of a sheet or layer of synthetic, non-woven stretchable fabric such as spandex, stretchable nylon or polyester mesh, or a flexible sheet of open mesh. However, it is understood that a second substrate layer may optionally be comprised of a sheet or layer of any material that is relatively flexible and stretchable and may be used as a sheeting structure, including, without limitations, natural or synthetic fabric (including, by way of example only and without limitations, polyester, nylon, Lycra®, or elastane), stretchable mesh (including open mesh), flexible or pliable plastic, neoprene, natural leather, synthetic leather, or a sheet of synthetic fiber, or a combination of such materials. Optionally, the second substrate layer may also be made of any flexible and stretchable sheet of foam, plastic, latex, silicone, rubber, other rubber-like materials, elastomer, and so forth, including any combination of such materials. Optionally, the second substrate layer may also be comprised of any such materials encased in, laminated with, or sandwiched between sheets of natural or synthetic fabric, or other materials. A suitable composition for the second substrate layer may optionally be selected from a wide variety and range of materials that are flexible and stretchable, provided that the resulting substrate layer may be made to bond to resilient elements (such as, by way of example only, resilient elements 353, 353A, 353B, 353C, and 353D).

In another aspect of the invention, the composition of the second substrate layer 352 may optionally comprise the same material or materials as the first substrate layer 351; alternatively, and optionally, the composition of the second substrate layer 352 may comprise different material or materials as the first substrate layer 351.

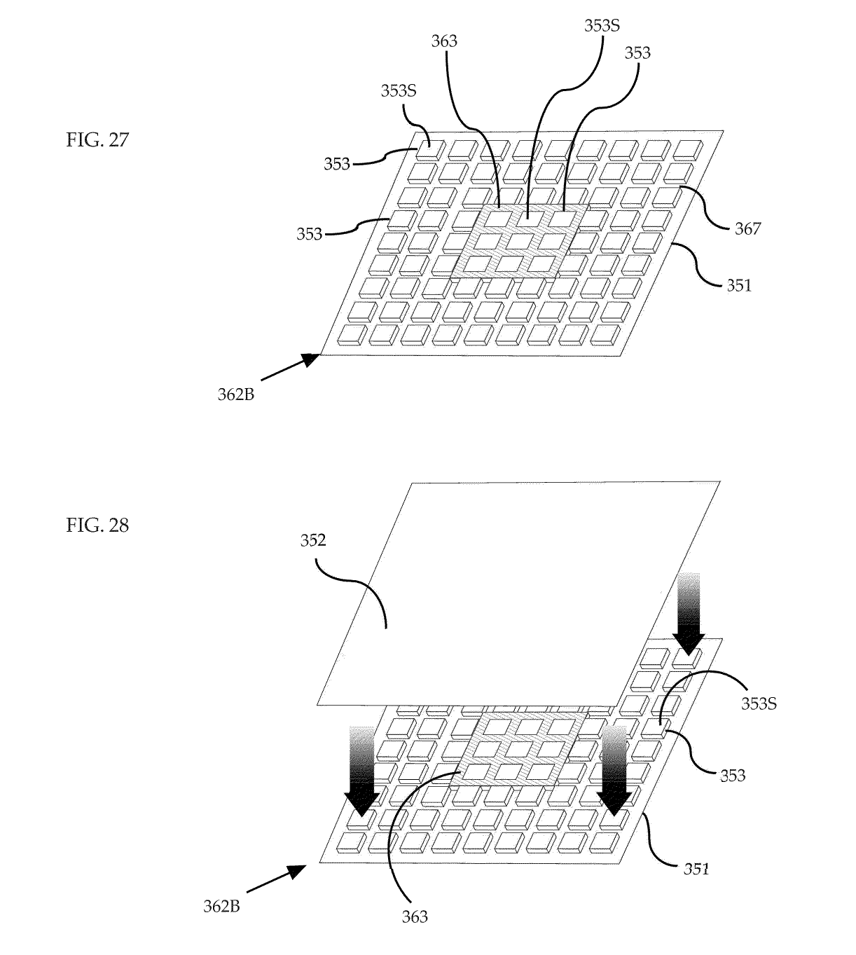

In yet another aspect of the invention, it is understood that second substrate may take on a variety of shapes and dimensions. FIGS. 25-26 and FIGS. 27-28 depict second substrate layer 352 as roughly rectangular in shape; however, it is understood that such shape is optional, and that second substrate layer 352 may be comprised of materials cut or shaped in any shape, size, dimension, or thickness, including irregular shapes and shapes that include apertures, holes, or openings. In another aspect of the invention, second substrate layer 352 may optionally be shaped so as to cover only some of the plurality of resilient elements, optionally leaving one or more resilient elements partially or completely exposed.

It is further understood that the process described above may be used to make a variety of double laminate composite materials, including, by way of example only and without limitations, first dual laminate composite 373 depicted in FIGS. 3A and 3B; alternative first dual laminate composite 374 depicted in FIGS. 4A and 4B; second dual laminate composite 375 depicted in FIGS. 1A-1B and FIGS. 31 and 32; alternative second dual laminate composite 375F depicted in FIG. 2; third dual laminate composite 376 depicted in FIG. 33; fourth dual laminate composite 377 depicted in FIG. 34; fifth dual laminate composite 378 depicted in FIGS. 35 and 36; and sixth dual laminate composite 379 depicted in FIG. 37.

The various dual laminate composites described above, or depicted in the above-referenced illustration, may optionally include one or more regions or zones that have a concave or convex shape, or a “half-pipe” shape. Alternatively, and optionally, the entire dual laminate composite material may take on a concave, convex, or a “half-pipe” shape. By way of example only, and without limitations, first dual laminate composite 373 is curved in three dimensions as shown in FIGS. 3A-3B, with a convex shape on its first side 350A, and a concave shape on its second side 350B.

It is understood that by varying the size, shape, and composition of the framing elements and the substrate layers, and the size, shape, and placement of the resilient elements, the resulting dual laminate composite material may take on a greater or lesser degree of concavity or convexity, or greater or lesser curvature.

Non-Limiting Example of an Article Made Using the Variably-Tensed Composite Cushioning Materials

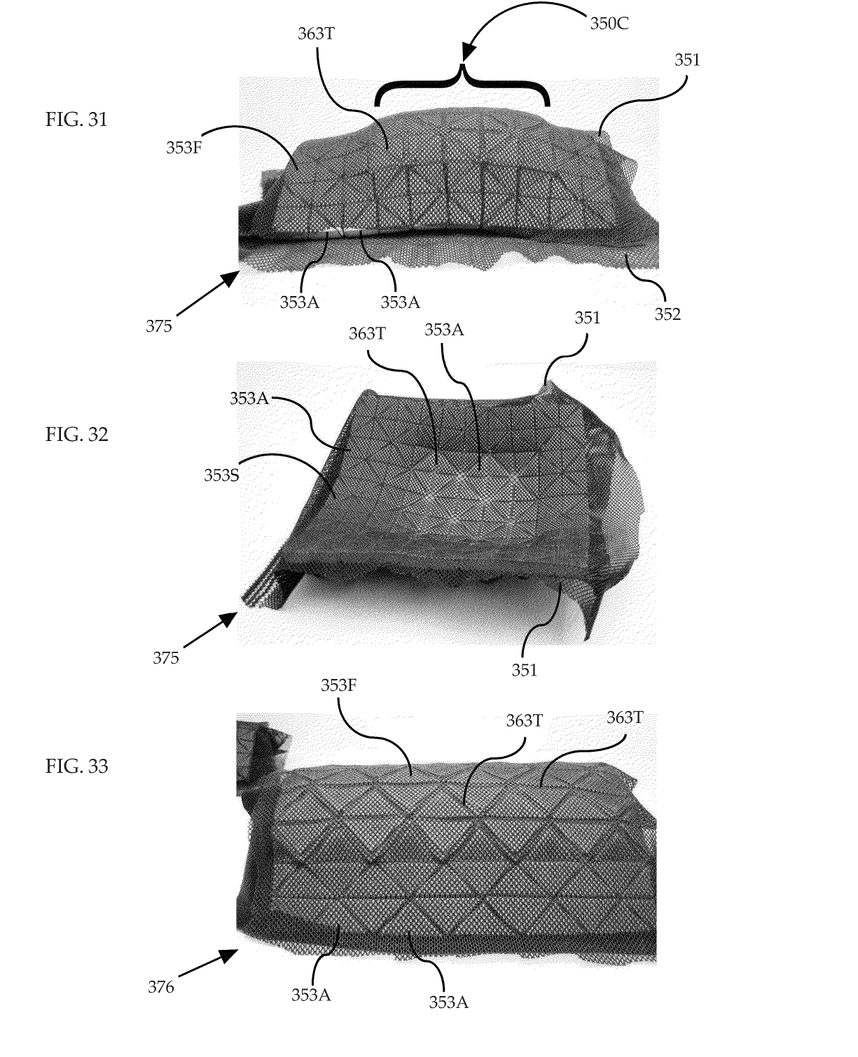

It is understood that various composite cushioning materials including one or two substrate materials or sheeting structures (such as, by way of example only and without limitations, first single laminate composite 370A depicted in FIG. 21, second single laminate composite 371 depicted in FIG. 22, first dual laminate composite 373 depicted in FIGS. 3A and 3B, and second dual laminate composite 375 depicted in FIGS. 31 and 32) may optionally be cut into other suitable shapes, for use as components in footwear (including shoe vamps, heels, or toe boxes), or as cushioning components or protective padding components in athletic or industrial protective gear.

FIGS. 38A and 38B depict a non-limiting example of a dual laminate composite (such as, by way of example, dual laminate composite 350) used to fabricate a padded elbow protector. The padded elbow protector is comprised of a flat sheet of dual laminate composite 350, rolled into a tube shape, wherein the two opposing edges are stitched or glued together to preserve the tubular shape.

In one embodiment of the invention, first substrate layer 351 of the dual laminate composite 350 depicted in FIG. 38A is comprised of open mesh or other lightweight and stretchable material. Second substrate layer 352 is comprised of Lycra® or other lightweight and stretchable fabric. The selection of elastic and stretchable materials for the two substrate layers makes the entire assembly flexible and stretchable, like an elbow warmer. The assembled tubular material may be slipped over the user's arm 278, until the variably-tensed zone 350C is positioned over the user's elbow area, as depicted in FIG. 38A.

FIG. 38B depicts a partial cut away view of the padded elbow protector (comprised of a dual laminate composite 350 rolled and stitched or glued into a tubular shape) with the first substrate layer 351 removed, so that its internal components are visible. As shown in FIG. 38B, the padded elbow protector includes a plurality of resilient elements 353C bonded to first substrate layer 351 and second substrate layer 352. In one embodiment of the invention, resilient elements 353C are cylindrically shaped, and made of EVA foam or an elastomer with shock absorbing characteristics. The resilient elements are bonded to the first substrate layer 351 and the second substrate layer 352 with hot-melt adhesive film or other similar adhesive compound. FIG. 38B depicts the resilient elements 353C as cylindrical in shape. However, it is understood that the resilient elements may be of any suitable shape, such as cuboids, cubes, elliptical cylinders, triangular prisms, hexagonal prisms, and the like.

As depicted in FIG. 38B, the padded elbow protector also includes a framing element 363K that engages some of the resilient elements 353C and spaces them apart from each other. It is understood that framing element 363K causes the spacing between those resilient elements engaged to the framing element to be greater than the spacing or space 367 between the resilient elements 353C that are not engaged to the framing element. It is also understood that the substrate layers 351 and 352 are more stretched out in the variably-tensed zone 350C, adjacent to the framing element 363, than in the rest of the assembly.

In one embodiment of the invention, framing element 363K is made of EVA foam, rubber, or other resilient foam material, and the framing element is not bonded to a substrate layer. However, it is understood that, optionally and alternatively, framing element 363K may be bonded to first substrate layer 351, second substrate layer 352, or to both of them.

It is understood that the padded elbow protector described above is a non-limiting example of one application of the composite cushioning material. It is also understood that the various components of the composite materials disclosed herein may be made of any suitable material and may be any size and shape consistent with their functions. The specific embodiments of the process disclosed and illustrated herein are not to be considered in a limiting sense as numerous variations are possible. Ordinal indicators, such as first, second or third, for identified elements in the specification and descriptions herein are used to distinguish between the elements, and do not indicate a required or limited number of such elements, and do not indicate a particular position or order of such elements unless otherwise specifically indicated. The subject matter of this disclosure includes all novel and non-obvious combinations and subcombinations of the various features, elements, functions and/or properties disclosed herein. No single feature, function, element or property of the disclosed embodiments is essential.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

Those skilled in the art will recognize, or be able to ascertain using no more than routine experimentation, many equivalents to the specific embodiments of the invention specifically described herein. Such equivalents are intended to be encompassed in the scope of the claims.

1. A composite cushioning material comprising two or more resilient elements bonded to one or more flexible or stretchable substrates, further comprising at least one framing element placed around one or more resilient elements, wherein a section of the composite cushioning material corresponding to the area of the framing element is less flexible than the rest of the composite cushioning material, so as to provide a variably tensed composite cushioning material.

2. The composite cushioning material according to claim 1, wherein the resilient element is composed of ethylene vinyl acetate foam, olefin or polyolefin foam, polyurethane foam, urethane based foam, thermoplastic foam, or other polymer foam, rubber, elastomer, or other resilient material, including a combination of any such materials.

3. The composite cushioning material according to claim 1, wherein the framing element is composed of ethylene vinyl acetate foam, olefin or polyolefin foam, polyurethane foam, urethane based foam, thermoplastic or thermoplastic foam, polymer foam, neoprene, natural leather, synthetic leather, elastomer, rubber, plastic, latex, silicone, or other similar material, including a combination of any such materials.

4-6. (canceled)

7. The composite cushioning material according to claim 1, wherein the framing element is composed of resilient material, comprised of:
(a) entirely of strips or bars of resilient material;
(b) a lattice of resilient material with apertures; or
(c) a combination of (a) or (b) in the same structure or on separate structures.

8-14. (canceled)

15. An athletic gear comprising the composite cushioning material of claim 1.

16. An industrial protective gear comprising the composite cushioning material of claim 1.

17. A shoe upper comprising the composite cushioning material of claim 1.

18. A shoe sidewall, shoe heel counter, or shoe toebox comprising the composite cushioning material of claim 1.

19. An elbow pad, knee pad, or shoulder pad comprising the composite cushioning material of claim 1.

20. A method of making the composite cushioning material of claim 1, comprising:
(i) applying a suitable adhesive to one or two opposing surfaces of a sheet of resilient material;
(ii) cutting the sheet of resilient material, to define and make a plurality of resilient elements;
(iii) bonding the plurality of resilient elements to at least one substrate layer;
(iv) stretching the substrate layer to which the resilient elements are bound, and increasing the relative distance between the resilient elements, thereby creating spacing between them;
(v) positioning one or more framing elements shaped and sized to engage one or more resilient elements, or placed between the resilient elements; and
(vi) inserting one or more framing elements between at least two resilient elements, or engaging one or more resilient elements to one or more apertures in the framing element.

21. The method according to claim 20, wherein in step (iv) the stretching occurs in an area or zone of the substrate layer to which the resilient elements are bound, and increasing the relative distance between the resilient elements positioned within the said area or zone of the substrate layer, thereby creating spacing between them.

22. The method according to claim 20, wherein in step (v) the framing element comprises:
(a) entirely of strips or bars of resilient material;
(b) a lattice of resilient material with apertures; or
(c) a combination of (a) or (b) in the same structure or on separate structures.

23. The method according to claim 20, comprising:
(vii) bonding a second substrate to the resilient elements so that the resilient elements and the framing element are sandwiched between the two sheets of substrates to form a dual laminate composite in which the framing element is not bound to either substrate.

24. The method according to claim 20, comprising:
(vii) bonding the framing element to a substrate layer, thereby making a single laminate composite with the framing element bound to one substrate.

25. The method according to claim 24, comprising:
(viii) bonding a second substrate to the resilient elements so that the resilient elements and the framing element are sandwiched between the two sheets of substrates to form a dual laminate composite in which the framing element is bound to one substrate.

26. The method according to claim 25, comprising:
(viii) bonding a second substrate to the resilient elements and the framing element so that the resilient elements and the framing element are sandwiched between the two sheets of substrates to form a dual laminate composite in which the framing element is bound to both substrates.

27-31. (canceled)

32. The method according to claim 20, comprising:
(vii) releasing the stretched out substrate so as to retract the substrate; and
(viii) bonding a second substrate to the resilient elements so that the resilient elements and the framing element are sandwiched between the two sheets of substrates to form a dual laminate composite.

33. The method according to claim 20, comprising:
(vii) releasing the stretched out substrate so as to retract the substrate;
(viii) bonding the framing element to the substrate layer, thereby making a single laminate composite; and
(ix) bonding a second substrate to the resilient elements so that the resilient elements and the framing element are sandwiched between the two sheets of substrates to form a dual laminate composite.

34. The method according to claim 20, wherein the resilient element is composed of ethylene vinyl acetate foam, olefin or polyolefin foam, polyurethane foam, urethane based foam, thermoplastic foam, or other polymer foam, rubber, elastomer, or other resilient material, including a combination of any such materials.

35. The method according to claim 20, wherein the framing element is composed of ethylene vinyl acetate foam, olefin or polyolefin foam, polyurethane foam, urethane based foam, thermoplastic or thermoplastic foam, polymer foam, neoprene, natural leather, synthetic leather, elastomer, rubber, plastic, latex, silicone, or other similar material, including a combination of any such materials.

36-40. (canceled)
